(19) United States
(12) Patent Application Publication
(10) Pub. No.: US 2018/0110669 A1
(43) Pub. Date: Apr. 26, 2018

(54) NON-INVASIVE MECHATRONIC DEVICE PROVIDING JOINT MOBILITY

(71) Applicant: INSTITUTO TECNLÓGICO Y DE ESTUDIOS SUPERIORES DE MONTERREY, Monterrey (MX)

(72) Inventors: Ernesto RODRIGUEZ LEAL, Monterrey (MX); Eduardo PIÑA MARTINEZ, Monterrey (MX); Ricardo Esteban ROBERTS UGRINOVIC, Monterrey (MX)

(21) Appl. No.: 15/566,663

(22) PCT Filed: Dec. 4, 2015
(86) PCT No.: PCT/IB2015/059340

§ 371 Date: Oct. 13, 2017

(30) Foreign Application Priority Data
Apr. 15, 2015 (MX) MX/A/2015/005567

(51) Int. Cl. A61H 1/02; B25J 9/00; B25J 9/16; B25J 13/08; B25J 13/00

(52) U.S. Cl. CPC A61H 1/0262; Y10S 901/46; A61H 1/0244; A61H 1/0277; A61H 1/0281; A61H 1/0285; B25J 9/0006; B25J 9/1694; B25J 13/087; B25J 13/006; A61H 2201/165; A61H 2201/501; A61H 2230/105; A61H 2230/605; A61H 2230/625; A61H 2001/0211; Y10S 901/09; Y10S 901/15; A61H 1/024

(57) ABSTRACT

A non-invasive mechatronic device providing joint mobility using EEG and EMG signals includes a medical device for non-invasively assisting movement of a first part of a body, the medical device comprising a stationary piece configured to be attached to a second part of the body, a movable piece configured to be attached to the first part of the body, an actuator that connects the stationary piece to the movable piece and is configured to move the movable piece relative to the stationary piece and a controller that receives an input signal and generates a control signal to control a movement of the actuator, based on the received input signal.

This application claims the benefit of Mexican Patent Application No. MX/a/2015/005567, filed on Apr. 15, 2015, the content of which is incorporated herein in its entirety by reference.

### BACKGROUND

### 1. Technical Field

The present example implementations relate to a non-invasive mechatronic device providing joint mobility using EEG and EMG signals, with specific applications such as limb motor rehabilitation and/or limb-motion assistance.

### 2. Related Art

The use of biosignals to control biomedical devices has motivated numerous studies. Patent CN101711709B discloses a device for controlling artificial hands using electrooculography (EOG) and electroencephalogram (EEG) signals. The device also uses eye movements to improve coordination of the artificial hand. Comparison of this patent with the proposed device shows that electroencephalogram (EEG) signals are used in the proposed device to identify the type of movement that the user wishes to perform, while the electromyography (EMG) signals provide feedback to the proposed device regarding the level of effort or pain (performance of muscle group being moved) generated in the muscles during movement. On detection of a level of effort greater than the established limit, the motion control device according to the proposed application sends an electrical signal commanding the actuator to aid with the task performed by the limb in accordance with the identified change in the following variables: movement type, intensity and frequency.

Publication US2012/0203079A1 discloses an invasive system for measuring EEG signals including an external device that is connected to measurement equipment, which enables interaction with other devices. The proposed device is a non-invasive system, which uses surface electrodes that are placed on the scalp and that receives EEG signals emitted from the cerebral cortex, and further acquires EMG signals taken from the surface of the skin by using at least a set of electrodes (e.g., three, but not limited thereto) per degree of freedom. In response to the captured EEG signals, the proposed device exerts couple/force to the human joints using actuators that are controlled in accordance with the force response monitored by the EMG signals, adjusting the intensity, frequency and amplitude of the movement with the objective of improving the force and mobility of the affected muscle groups.

Patent ES2 370 895 discloses a non-invasive device to provide movement or rehabilitation to the joints of an upper limb of the human body using traction cables that pull and move the arm where the user desires. Compared with this patent, the device proposed in this application is much lighter due to the fact that it only uses at least two attachment bars per joint and, depending on the application, it may be made of thermoplastics such as PLA or ABS, or metals such as steel or aluminum. Furthermore, the device proposed in this application can control up to 11 exoskeletons, providing mobility or rehabilitation to all of the joints of the limbs of the human body, in all cases controlled using EEG signals while monitoring the EMG signals of the user at all times to detect when the limits are reached and stop the related movement to prevent injury or extreme pain being caused when performing the movement.

### SUMMARY

Aspects of the example implementations relate to a non-invasive mechatronic device providing joint mobility using EEG and EMG signals wherein it is carried by a person and includes a control system connected to a set of EEG sensors, in the form of a headband or cap, in constant communication while the device is on, and by a wired connection to at least one exoskeleton surrounding a joint to assist in its motion or rehabilitation. When this mechatronic device is used for the first time, it must be calibrated, for which it is connected to an electronic device such as a computer, a cell phone or a tablet running an application for this purpose. Moreover, the control system is embedded in a garment that is worn on the user's body and is formed by: a. a processor that is operationally connected to: b. an on/off switch to turn the device on or off, the device being connected to, c.a USB port enabling communication with the electronic device for calibration of the mechatronic device, d. a memory port for storing information relating to the rehabilitation routines or motion assistant, e. at least one connection module for communication with the set of EEG sensors (and optionally EMG sensors), with an electronic device such as a computer, cell phone or tablet; f. a routine selector enabling the information related to the rehabilitation routine or motion assistant selected to be downloaded and implemented, which sends information to, g. a screen for displaying data relating to calibration and the routines to be performed, h. a power source for energizing the mechatronic device, which is connected to: i. a power interface that powers at least one exoskeleton comprising at least one actuator per degree of freedom of the joint, where the actuator is connected to (a) a static link made of a rigid material surrounding the proximal muscle of the joint that is attached using at least one adjustable band, (b) a movable link made of rigid material that surrounds the distal muscle of the joint that is attached using at least one adjustable band, and (c) a set of non-invasive EMG sensors per degree of freedom of the joint to sense the level of muscular effort and/or the pain threshold of the user's muscle.

According to another example implementation, a medical device is provided for non-invasively assisting movement of a first part of a body, the medical device comprising a stationary piece configured to be attached to a second part of the body; a movable piece configured to be attached to the first part of the body; an actuator that connects the stationary piece to the movable piece and is configured to move the movable piece relative to the stationary piece; and a controller that receives an input signal and generates a control signal to control a movement of the actuator, based on the received input signal.

Further, the medical device may include a body cover that covers the body, and is interspersed between the body and the medical device. The body cover may include an electromyography—sensitive region on the body cover that senses electrical potential generated by a muscle in the first part of the body, and provides the input signal to the controller.

Further, the medical device may include an electromyography sensor remotely positioned from the medical device on the first part of the body, wherein the electromyography sensor senses electrical potential generated by a muscle in the first part of the body, and provides the electrical potential as the input signal to the controller.

Further, the medical device may include an electroencephalograph (EEG) sensor remotely positioned on a third part of the body, wherein the EEG sensor senses neural information of the body, and provides the neural information as the input signal to the controller.

Further, the input signal may be an instruction generated by at least one of a health care service provider and a user associated with the body. The input may alternatively be an instruction to operate in a first mode associated with supplementing a strength of the first part of the body to assist with motor tasks for the body, or a second mode associated with a rehabilitation of the first part. For the input signal comprising the instruction to operate in the second mode, the medical device may also include an augmented reality user interface that provides a user with a routine to support the rehabilitation of the first part of the body.

Further, the first part of the body is a joint, and the actual is a rotary actuator associated with assisting in movement of the joint.

According to another example implementation, a non-transitory computer-readable medium is provided that is configured to provide instructions for a medical device for non-invasively assisting movement of a first part of a body, the medical device including a stationary piece configured to be attached to a second part of the body, a movable piece configured to be attached to the first part of the body, and an actuator that connects the stationary piece to the movable piece and is configured to move the movable piece relative to the stationary piece, the instructions, comprising receiving an input from an external source, wherein the input comprises at least one of a received body parameter associated with muscle activity or neural activity, and an input generated by a user or a health care service provider; processing the input to determine whether a mode of the medical device is in a motor task assistance mode or a rehabilitation support mode, and to determine the level of assistance based on at least one of the muscle activity and the neural activity; generating a control signal that determines the movement of the actuator, based on the determined level of assistance and the determined mode of the medical device; and transmitting the control signal to the actuator, with an instruction for the actuator to move in a prescribed manner.

### BRIEF DESCRIPTION OF FIGURES

A general architecture that implements features of the disclosure will now be described with reference to the drawings. The drawings and the associated descriptions are provided to illustrate implementations of the disclosure and not to limit the scope of the disclosure. Through the drawings, reference numbers are reused to indicate correspondence between referenced elements.

FIG. 1. Block diagram of the parts that comprise the mechatronic device.

FIG. 2. Block diagram with the elements that include the control system.

FIG. 3a. Internal schematic representation of an exoskeleton for the elbow joint.

FIG. 3b. External schematic representation of an exoskeleton for the elbow joint.

FIG. 4a. External schematic representation of the exoskeletons for the shoulder and elbow joints.

FIG. 4b. External schematic representation of the exoskeletons for the shoulder and elbow joints, and the part containing the control system.

FIG. 5a. Front schematic representation showing the implementation of the mechatronic device for a person.

FIG. 5b. Side schematic representation showing the implementation of the mechatronic device for a person.

FIG. 5c. Rear schematic representation showing the implementation of the mechatronic device for a person.

FIG. 6a. Side view of the range of movement of the shoulder joint, with arm flexion and extension.

FIG. 6b. Front view of the range of motion of the shoulder joint, with arm adduction and abduction.

FIG. 7 illustrates an example implementation of the exoskeleton, including structural aspects.

FIG. 8 illustrates an isometric frontal view of the exoskeleton according to the example implementation.

FIGS. 9 and 10 respectively illustrate a front view and a back view of the exoskeleton device, which shows both arms, connected to the back piece.

FIG. 11 illustrates a cover layer according to an example implementation.

FIG. 12 illustrates an EEG sensor according to an example implementation.

FIGS. 13(a)-13(c) illustrate augmented reality equipment according to an example implementation.

FIG. 14 illustrates example semi liquid polymer medical grade gel material according to an example implementation.

FIG. 15 illustrates contacts of an EEG sensor according to an example implementation.

FIG. 16 illustrates an EMG sensor according to an example implementation.

FIG. 17 illustrates an EMG sensor electrode according to an example implementation.

FIG. 18 illustrates a tablet according to an example implementation.

FIGS. 19-22 illustrate a user operation according to an example implementation.

FIGS. 23-24 illustrate an exoskeleton on a user according to an example implementation.

FIG. 25 illustrates an EEG sensor as a wearable headset according to an example implementation.

FIG. 26 shows an example environment suitable for some example implementations.

FIG. 27 shows an example computing environment with an example computing device suitable for use in some example implementations.

FIGS. 28-54 provide additional use examples of the example implementations.

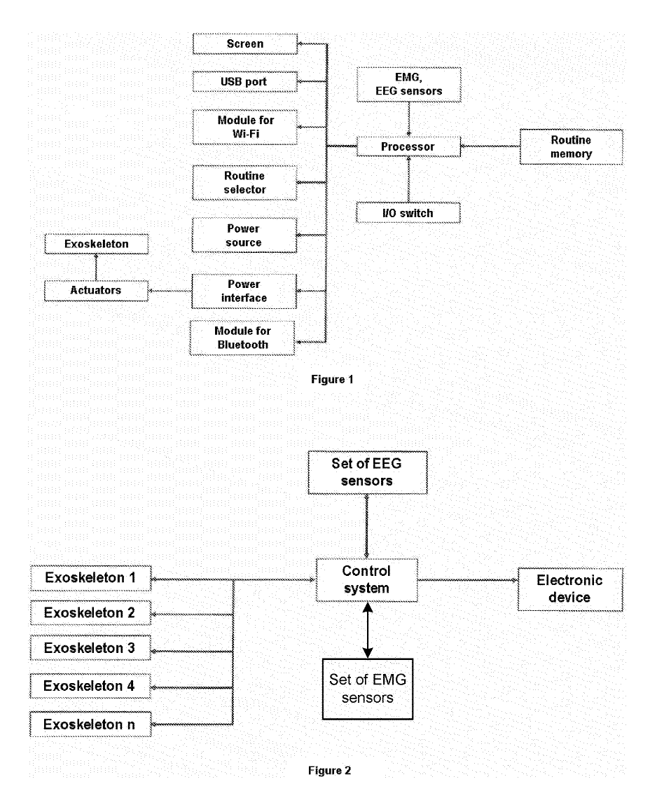

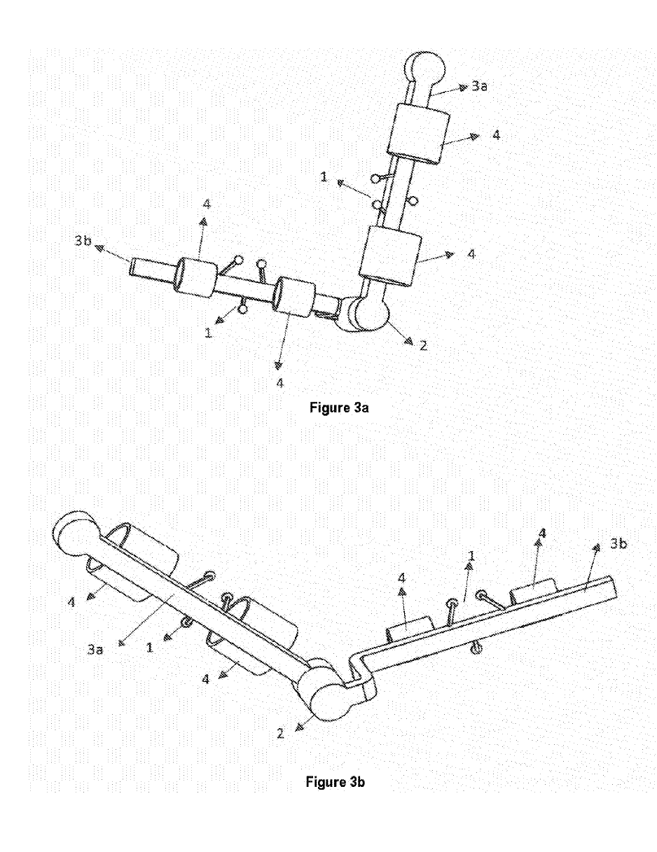

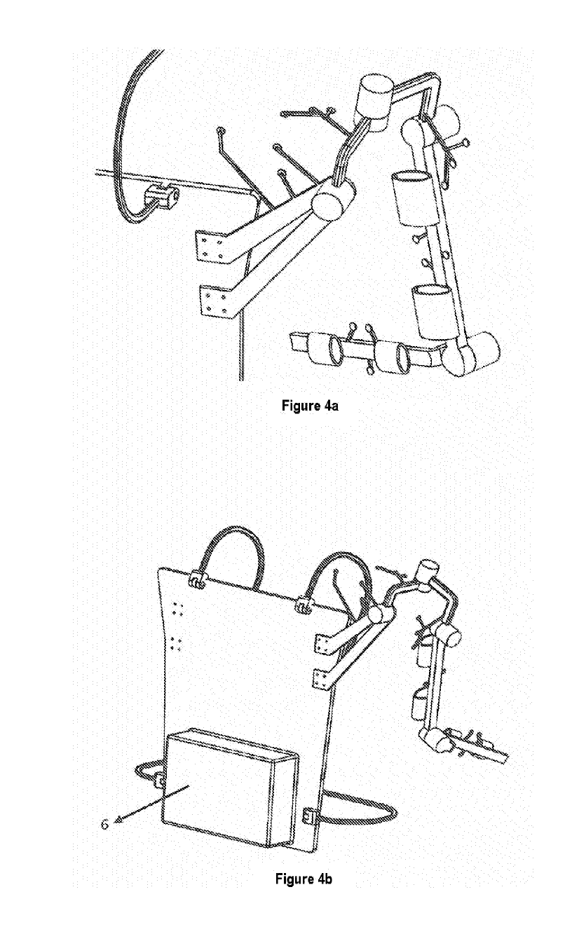

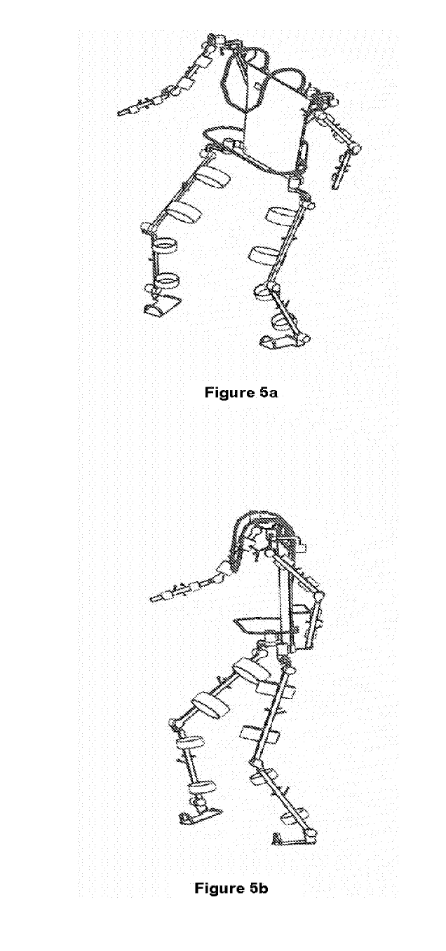

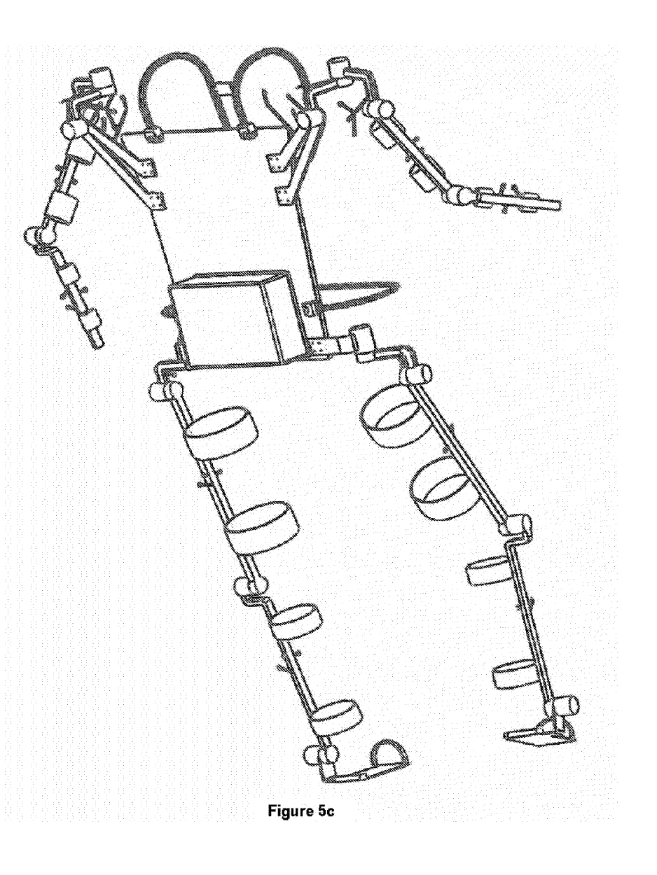

### DETAILED DESCRIPTION

The subject matter described herein is taught by way of example implementations. Various details may have been omitted for the sake of clarity and to avoid obscuring the subject matter. The examples shown below are directed to apparatuses and structures for implementing non-invasive mechatronic device providing joint mobility using EEG and EMG signals.

The non-invasive mechatronic device providing joint mobility using EEG and EMG signals comprises at least one exoskeleton that is made of rigid material to withstand deformations, and that is waterproof, lightweight, corrosion resistant, and resistant to impacts and stress to prevent fracturing under normal operating loads. These materials may include (a) thermoplastics such as acrylonitrile butadiene styrene (ABS), (b) metals such as aluminum, (c) alloys such as steel, or (d) composite materials such as carbon-fiber reinforced polymers.

The device is associated with a specific joint. The exoskeleton is connected electrically to a control system (5) that is further connected, either wirelessly or by wire, to a set of EEG sensors (6) in the form of a headband or cap that maintains a constant communication while the device is turned on, and by a wired connection to at least one exoskeleton used to assist motions or to rehabilitate one or more joints of the limbs of the human body, and with a set of EMG sensors. According to an example implementation, the battery may be centralized and commonly used for all of the individual exoskeletons connected to one other, or the battery may be supplied modularly for each of the exoskeletons (e.g., each exoskeleton separately powered).

The device needs to be calibrated when used for the first time, this is performed by establishing a connection with an electronic device (12) such as a computer, a cell phone or a tablet running an application for this purpose. The control system (5) is embedded in a garment that is worn on the user's body and is formed by:
a. a processor (7) that is operationally connected to:
b. an on/off switch (8) to turn on or off the device that is connected to,
c. a USB port (9) enabling communication with the electronic device for calibration of the mechatronic device,
d. a memory (10) for storing information relating to the rehabilitation routines or motion assistant,
e. at least one connection module (11) for communication with the set of EEG sensors and/or EMG sensors (6), with an electronic device (12) such as a computer, cell phone or tablet;
f. a routine selector (13) enabling the information related to the rehabilitation routine or motion assistant selected to be downloaded and implemented, which sends information to,
g. a screen (14) for displaying data related to calibration and the routines to be performed,
h. a power source (15) for energizing the mechatronic device, which is connected to:
i. a power interface (16) that powers at least one exoskeleton comprising at least one actuator (2) per degree of freedom of the joint, this actuator is connected to (a) a static link (3a) made of a rigid material that surrounds the proximal muscle of the joint and is attached by using at least one adjustable band (4), (b) a movable link (3b) made of rigid material that surrounds the distal muscle of the joint and is attached by using at least one adjustable band (4), and (c) a set (e.g., three) of non-invasive EMG sensors (1) per degree of freedom of the joint for sensing the level of muscular effort and/or the pain threshold of the user's muscle.

The processor (7) receives signals from the set of EEG sensors (6) that are arranged in the form of a headband or cap on the user's head that sense, in a non-invasive manner, the neuronal activity that emit the signals, which move the human body. These signals are further transmitted to the exoskeleton or exoskeletons, generating the movement required by the user in the surrounded joint or joints.

The mechatronic device must be calibrated before any of the operating modes are used. During this process, the user places the headband or cap on the head appropriately to measure the electroencephalography (EEG) signals and the exoskeleton on the joint or joints to be worked, ensuring there is adequate contact between the skin and the set of EMG sensors (1) to sense the electromyography signal, the power interface (16) of the device sends a message to the screen (14) with information on the connection state of the set of the EMG sensors (1). Using the electronic device (12) connected to the mechatronic device, the teaching of the device is undertaken using specific movements of the user's limb or limbs to be assisted or rehabilitated. Moreover, the mechatronic device performs controlled calibration movements that validate the teaching process, while the muscle response of the muscles involved in the movement is calibrated in order to find the limits of effort and saturation of the muscle, as well as any discomfort or pain. It is noted that the number of EMG sensors per joint is not limited to a particular number, such as three, as a set of sensors is provided per each joint. Due to physiological constraints, some joints may be too complex to be measured by a single EMG sensor. Thus, for example, two EMG sensors and one reference or ground may be shared with other EMG sensor pairs.

The invention can be used in two modes:
(i) to assist with motor tasks, or (ii) as a rehabilitation device.

In the operating mode for assisting with motor task performance, the processor (7) begins receiving the signal sent by the set of EMG sensors (1) from at least one exoskeleton, and the set of EEG sensors (6). The processor classifies the intended movement of the user, calculating and recording the trajectory followed by the device simultaneously. This information is kept in the memory (10) of the device. In parallel, the processor receives the signal sent by each of the sets of EMG sensors (1), classifying the level of effort of the muscle group responsible for each degree of freedom in the limb or limbs being assisted. A control algorithm determines the need to supply torque to each joint in accordance with the level of effort sensed in the respective muscle group. The processor (7) sends an electric signal to each actuator (2), which is transformed into a couple that is applied to the joint according to the required torque.

When the device is in the rehabilitation operating mode, the intended movement of the user is controlled by pre-programmed movement routines; detecting and classifying the EEG signals provided by the set of EEG sensors is also performed, along with detecting of the EMG signals (6) or by EMG signals provided by the set of EMG sensors or by selecting a predefined route or trajectory. The power interface (16) determines the amplitude of movement, the frequency and the power supplied by the actuators (2) in consideration of the levels of effort of the muscles determined from the EMG signals. The EEG and EMG recording devices described herein (e.g., sensors) are recording and analyzing the signals, and can sent control signals to adjust or abort the pre-programmed routines. The routine selector (13) automatically adapts the aforementioned parameters in accordance with the rehabilitation routines set out in the program of the control system (5). The mechatronic device maintains the movement until an intention of the user to stop is detected or, when the time established in the routine has elapsed, or when the level of effort of the muscle so requires.

Example of the Preferred Implementation on the Shoulder (Glenohumeral/Scapulohumeral)

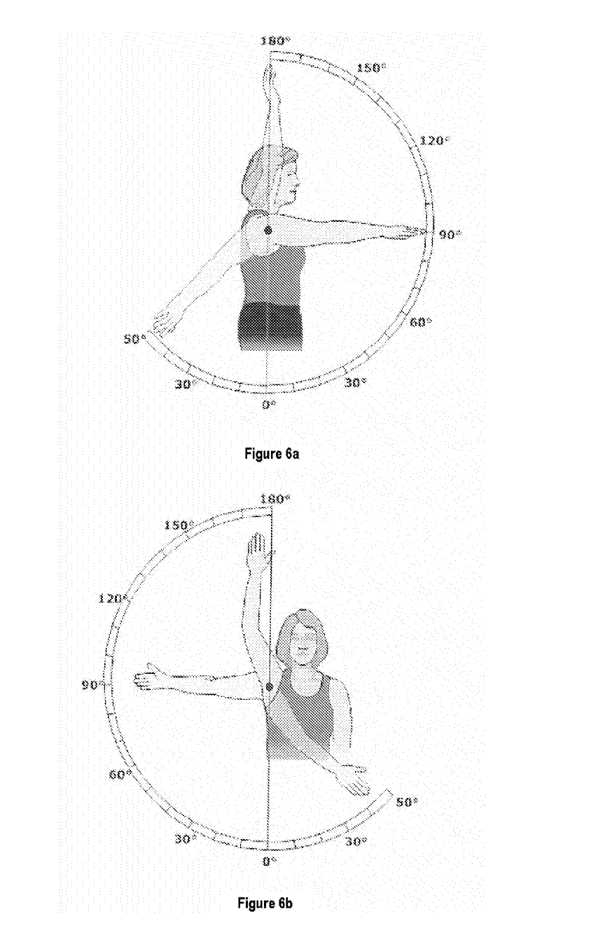

The mechatronic device for the shoulder joints in the arm comprises two L-shaped movable links and one static link parallel to the humerus, all made of 6063 T-5 aluminum, and an arm support that are interconnected by means of actuators (e.g., three) that provide corresponding degrees of freedom (e.g., three) to the glenohumeral joint, where abduction/adduction (FIG. 6b), flexion/extension and circumduction (FIG. 6a) movements are performed. Each motor is used to cover one axis:
1) Sagittal axis. The actuator 1 is used for abduction and adduction movements. The lateral rotation of the humerous increases the amplitude of the abduction. The primary motor muscle for abduction is the central portion of the deltoid and is innervated by the axillary nerve. For adduction, the muscle used is the pectoralis major, innervated by the lateral and medial pectoral nerves (gravity is the primary motor when standing with no resistance).
2) Longitudinal axis. The actuator 2 is used to generate medial and lateral rotation. The subscapularis muscle is the primary motor for medial rotation, innervated by lateral roots of the posterior cord with C5 and C6 fibers. Lateral rotation is performed using the infraspinatus muscle, innervated by the suprascapular nerve (C4-C6).
3) Transverse axis. The actuator 3 is used for flexion and extension movements. Flexion involves the pectoralis major and the deltoid, and as such innervation is provided primarily by the axillary nerve. Extension is performed by the deltoid and the teres major muscle (innervated by the axillary nerve and subscapular roots of C5 and C7).

The ranges of movement achieved are as follows: abduction/adduction up to 150°, flexion 180°, extension up to 60°, external rotation 90° and internal rotation 90°.

The exoskeleton is supported by a base that is preferably placed on the user's back and includes all of the electronics of the device. Moreover, the arm is attached by a link that is oriented parallel or almost parallel to the humerous.

Each degree of freedom of the shoulder joint has at least two EMG sensors (e.g., each having at least three surface electrodes) that are ideally arranged on the largest surface of the agonist and antagonist muscle group for each movement type (as described above).

The EEG electrodes placed on the user's head sense the signal emitted by the brain to inform the shoulder of the movement to be performed in the glenohumeral joint. The EEG signals captured by the electrodes in the headband or cap are sent wirelessly or by wireline to the processor.

Finally, the processor receives the myoelectric (EMG) and cerebral (EEG) signals and uses an algorithm to compare and adjust the signal, before sending an operational signal to each of the motors that supply torque by varying the electrical current.

According to another example implementation, a device is provided to support a user with bodily movement. For example, but not by way of limitation, an exoskeleton device that is wearable by a user may be provided to assist a user to maintain to increase a degree of movement. In the case of a user having mobility difficulty (e.g., patient having pain due to joint wear or related conditions, such as arthritis), the exoskeleton provides implements physiological parameters, including (but not limited to) EMG and EEG. The physiological parameters may be used for control feedback. In addition to the physically wearable exoskeleton, a user interface (UI) may be provided for the user to interact with the exoskeleton device during use (e.g., rehabilitation).

In addition to joint wear or related conditions that might be present in elderly users, the example implementations are also directed to assisting users that can barely move, for example, due to neurodegenerative diseases. The device may be programmed (e.g., by a health care service provider such as a doctor) to provide a user with one or more rehabilitation routines that may maintain or improve recovery of mobility, strength or other physical attribute of the user for body joints (e.g., shoulder, girdle, elbow, wrist, hip, knee, or the like).

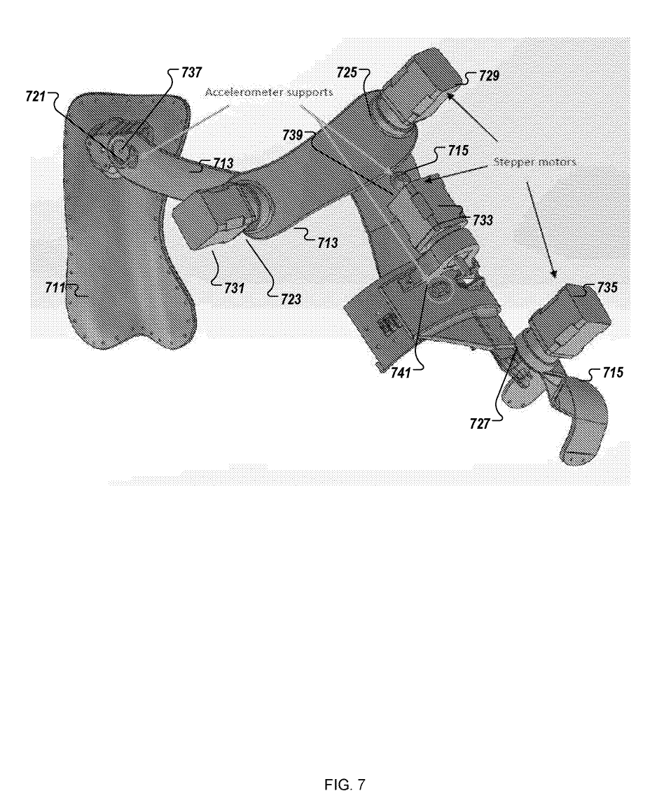

FIG. 7 illustrates an example implementation of the exoskeleton, including structural aspects. The exoskeleton is configured to operate in four of the five degrees of freedom (DOF) associated with the girdle, plus one DOF for the elbow joint. However, the present example implementation is not limited thereto, and other DOFs may be substituted therefor in accordance with usage for other joints, conditions, or purposes, as would be understood by those skilled in the art.

As shown in FIG. 7, which is an isometric view showing the right arm, the exoskeleton device according to the example implementation includes a back piece 711, connecting arms 713 (e.g., clavicle piece, shoulder main piece, arm piece, forearm piece), arm portions 717, 719, and joint pivot portions 721, 723, 725, 727. Further, stepper motors 729, 731, 733, 735 are provided, as well as accelerometer supports 737, 739, 741. The back piece 711 includes a main controller (not shown), which provides control signals to the stepper motors 729, 731, 733, 735 and the accelerometer supports 737, 739, 741, to control the parameters of operation (e.g., speed, duration, range of motion, number of repetitions), in accordance with the program of operation for the condition.

For example, but not by way of limitation, with respect to a condition such as arthritis, a routine may be selected that does not cause pain to the user, but increases mobility. On the other hand, with respect to an injury rehabilitation routine, a routine may be selected that provides some support to increase flexibility or range of motion of the user's joints, without causing injury or discomfort.

As a power supply for the exoskeleton device, a storage device such as a battery may be employed (not shown). Additionally, for safety and proper fitting to the user, a structure that performs the function of securing or attaching the exoskeleton to the user may also be provided, such as one or more straps (not shown). Other features may be provided for user comfort, such as padding or related structures (not shown).

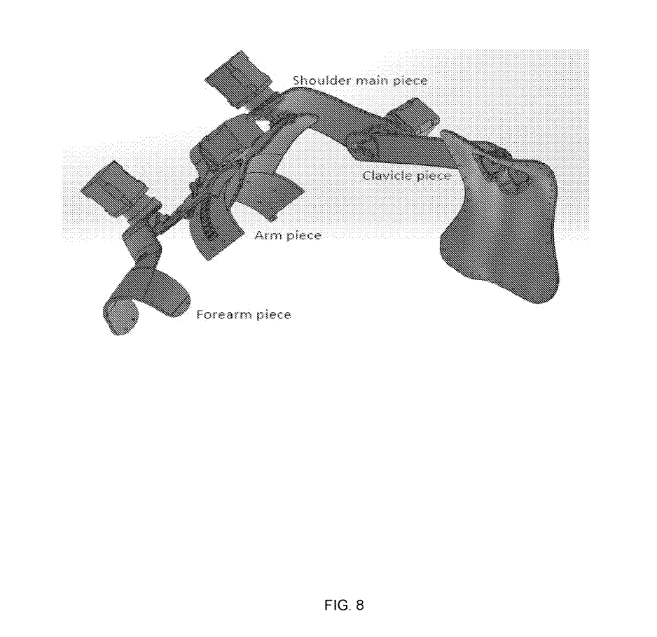

FIG. 8 illustrates an isometric frontal view of the exoskeleton according to the example implementation. The reference numerals shown in FIG. 7 are repeated in FIG. 8 to represent that the elements are the same; their further explanation is omitted for the sake of clarity. As can be seen in FIG. 8, the back piece attaches to the connecting arms by way of the joints, and the stepper motors and accelerometer supports are also shown.

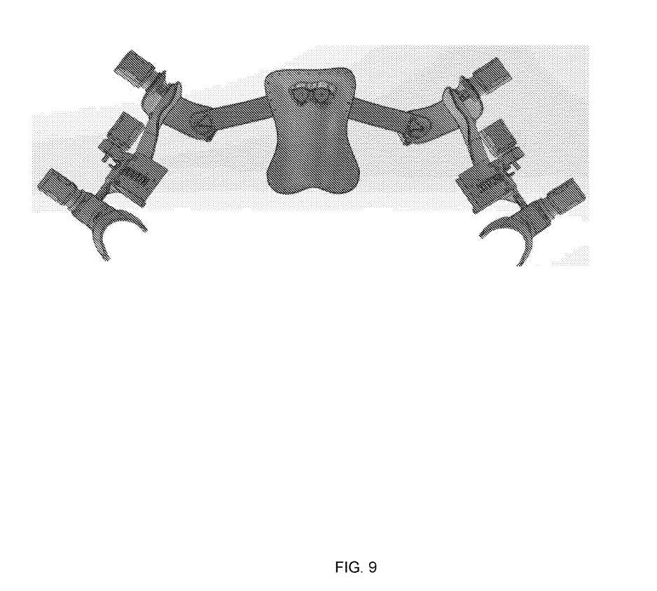

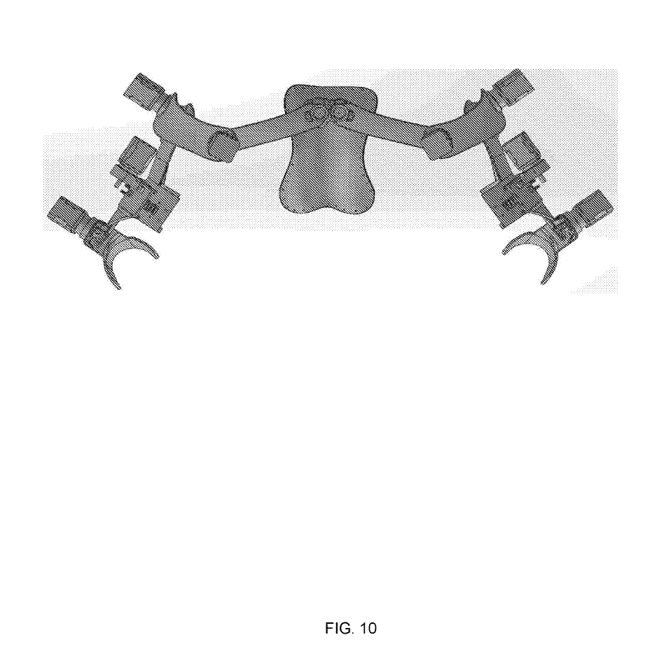

FIGS. 9 and 10 respectively illustrate a front view and a back view of the exoskeleton device, which shows both arms, connected to the back piece. The exoskeleton is mobile and does not require wiring or other supports, such that the user can wear the exoskeleton without substantially interfering with daily routine activities.

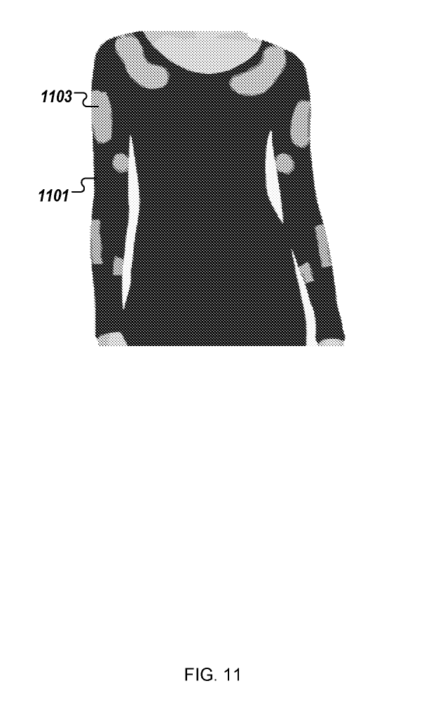

FIG. 11 illustrates a cover layer 1101 according to an example implementation. According to the example implementation, an option may be provided to enclose the exoskeleton device in the cover layer 1101 (e.g., fabric suit or skin). The cover layer 1101 provides a contact interface between the body of the user and the exoskeleton. More specifically, the cover layer 1101 may include areas of EMG sensing 1103 in the conductive fabric. As a result, the user may be able to fit his or her body to the position of every sensing zone associated with the EMG sensing areas 1103 that is required for EMG feedback. The cover layer 1101 may be made from a commercially available fabric, including (but not limited to) a textile fabric such as polyester microfiber (e.g., dry-fit), polypropylene, or the like.

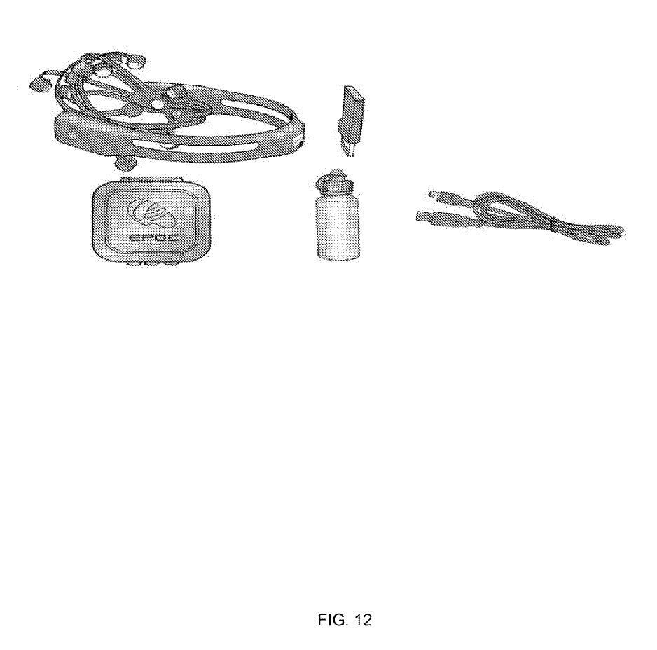

In addition to the foregoing example implementation having the EMG sensing areas that receive input associated with an actual state of the muscles, EEG signals may also be used as an input, to provide information associated with the intention of the user's movement. For example, but not by way of limitation, an EEG signal sensor, such as that shown in FIG. 12, may be employed to receive the EEG signals, and transmit them for further processing. With respect to the EEG sensor in the headset, the following elements may be included, as shown in FIG. 12: headset Assembly with Rechargeable Lithium battery already installed; USB Transceiver Dongle; Hydration Sensor Pack with 16 Sensor Units; Saline solution; 50/60 Hz 100-250 VAC Battery Charger or USB charger. FIG. 12 illustrates a Neuroheadset Emotiv EPOC; however, other EEG input devices may be substituted therefor without departing from the inventive scope. Optionally, the above-described EMG sensors may be communicatively coupled in the same manner.

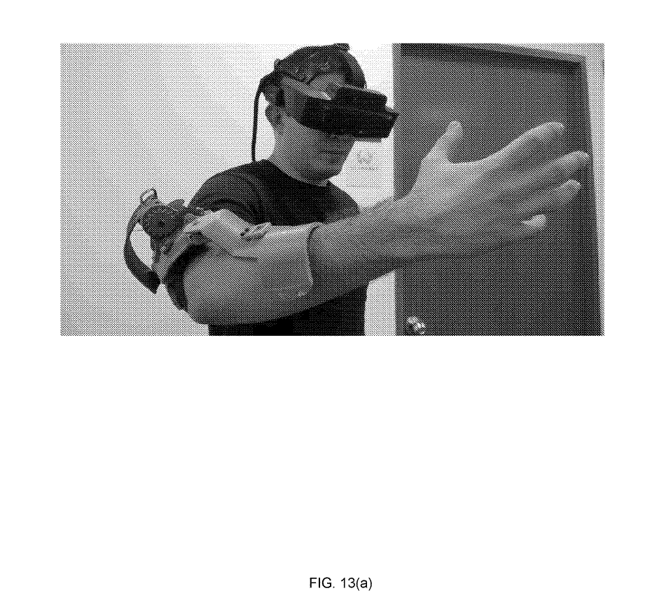

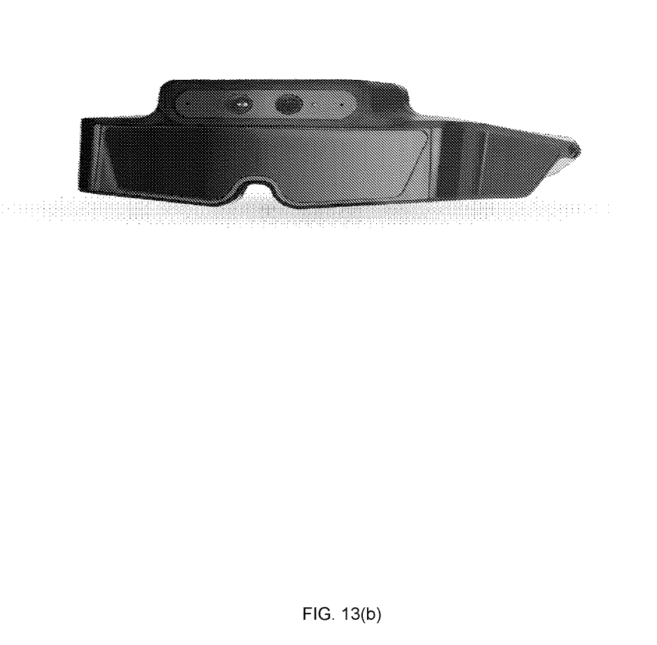

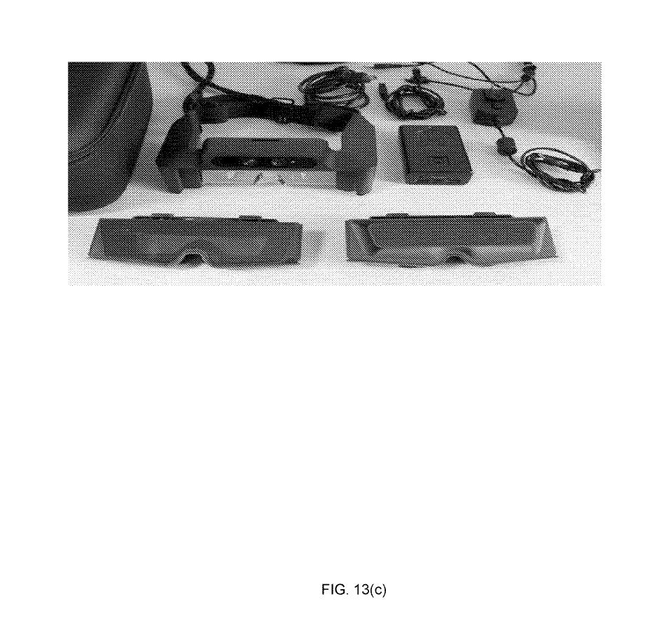

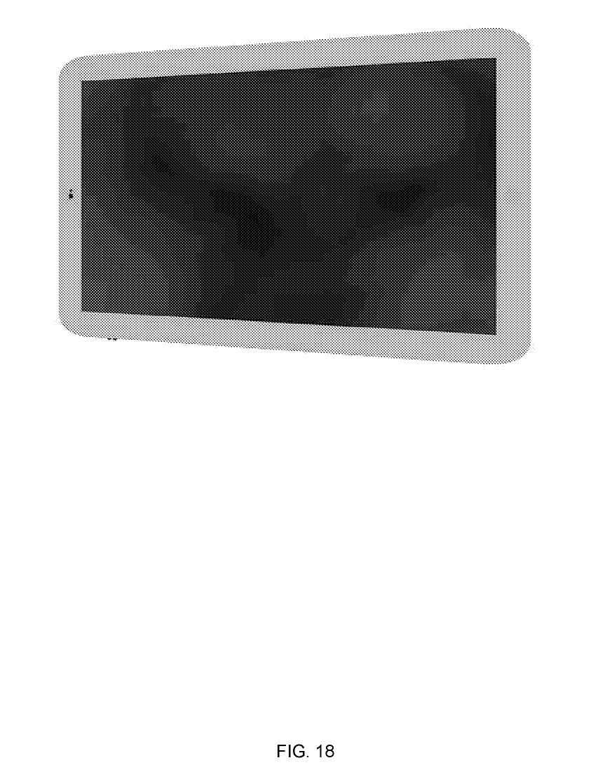

The exoskeleton device of the example implementation has two operating modes: rehabilitation and movement assistance. In the rehabilitation mode, the user can use a device having a user interface (e.g., tablet), and may provide an input on the device indicative of a desired rehabilitation routine. The tablet, as shown in FIG. 18, may thus guide the user through the desired rehabilitation routine. According to another example implementation, an augmented reality input/output device, such as augmented (or virtual) reality glasses shown in FIGS. 13(a)-13(c), may be used to provide a user with a unique user experience that may result in a more enjoyable rehabilitation experience (e.g., faster and/or more fun). This example implementation may also provide additional functionality, because the augmented/virtual generated 3D spaces and geometries are associated with a path/projectory as established by the rehabilitation routine). FIG. 13(b) illustrates the augmented reality glasses, and FIG. 13(c) illustrates augmented reality glasses with two interchangeable lenses, charger and USB connection cables.

In view of the foregoing, a user may wear the exoskeleton (including cover layer and EMG sensing zones), EEG sensor, and augmented reality input/output device, so as to provide the user with a user experience that resembles a desired body movement for the desired rehabilitation.

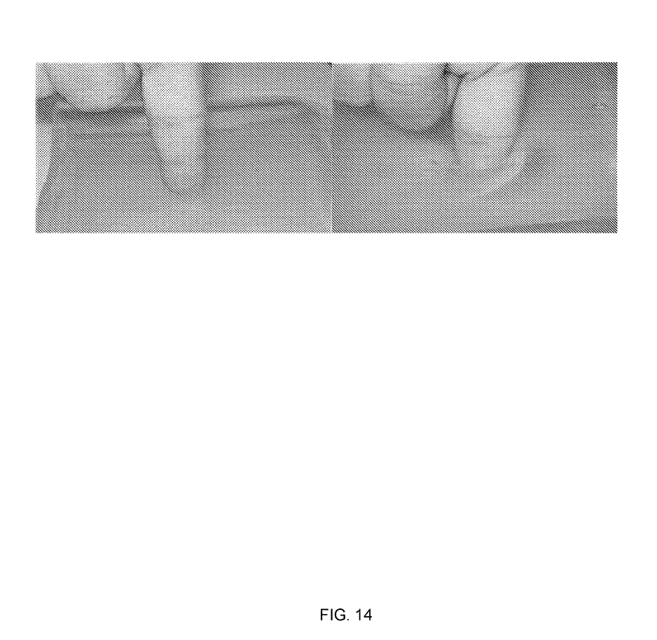

As explained above, a cover layer is provided. More specifically, the body of the user may directly contact the cover layer, and the cover layer may include silicon or medical grade gel pads, which are skin biocompatible and provide a cushioned interface. FIG. 14 illustrates example semi liquid polymer medical grade gel material. As explained above, the cover layer may include (but is not limited to) a polyester microfiber (dry-fit) or polypropylene suit with a conductive fabric having EMG sensing regions or areas.

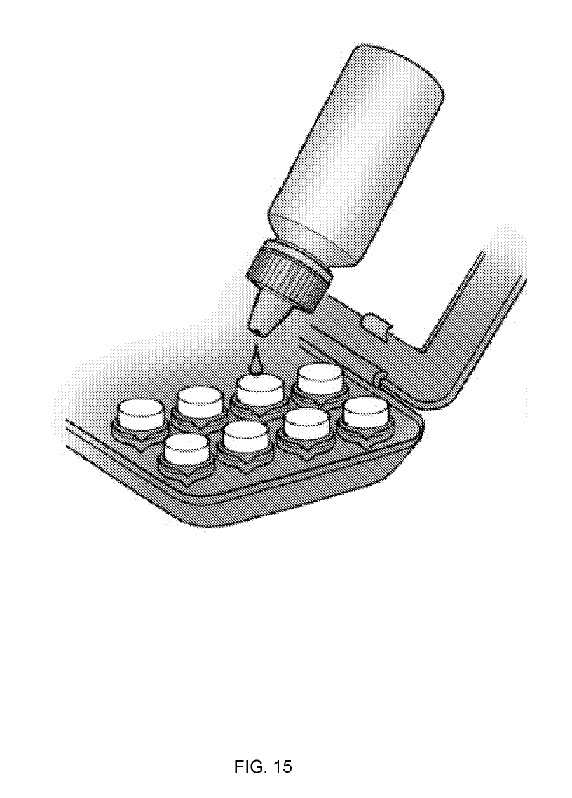

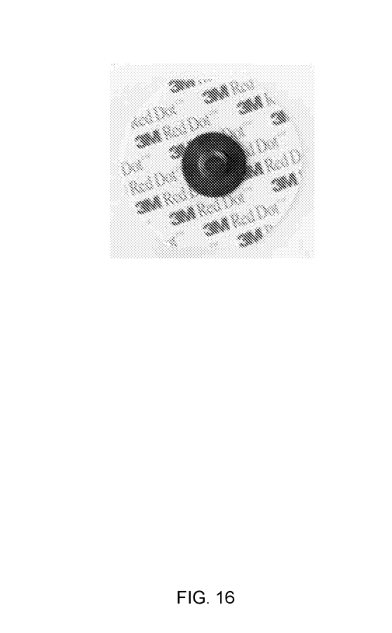

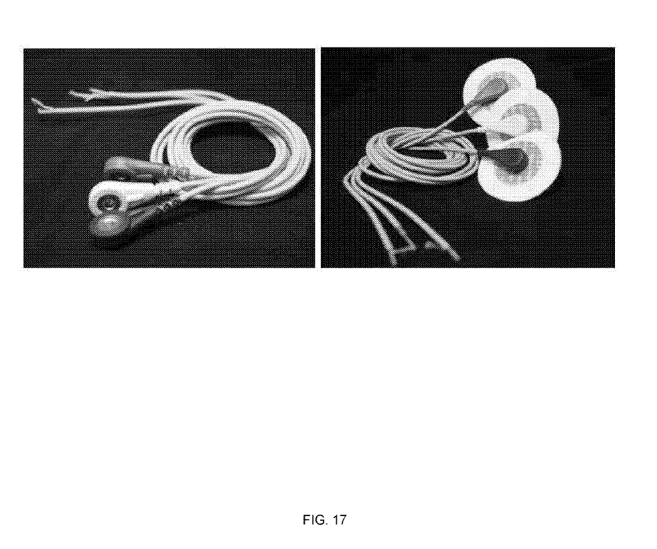

The above-described EEG and EMG sensors may directly contact the body of the user (e.g., skin), and may have biocompatibility properties. For example, but not by way of limitation, the EEG sensors may be felt-based assemblies with gold-plated contacts as shown in FIG. 15, and may be contained on the neuroheadset as explained above. Further, the EMG sensors, as shown in FIG. 16, may be disposable silver/silver-chloride coated plastic that works with a conductive saline gel, and may employ electrodes that are commonly used for ECG sensing, as shown in FIG. 17. Alternatively, the EMG sensors may be integrated with the cover layer, as explained above.

The foregoing example implementation may include a control system that is embodied in software (e.g., a non-transitory computer readable medium having instructions stored thereon, that are executed on a processor) associated with the exoskeleton device and related peripheral devices. More specifically, the exoskeleton device includes programed software to control the functioning of the inputs and outputs associated with the feedback systems (e.g., EMG, EEG, accelerometers, etc.), engines, user interface and remote signal transmission. In addition, the exoskeleton may employ an augmented reality platform that may execute with Unity, and an online mobile application that receives the EMG, EEG, and positioning (pose) of the exoskeleton, as well as other parameters, and provides this information to a health care professional such as a physician, or automatically feeds this information into a rehabilitation control program.

According to an example implementation, a user may perform operations as explained below.

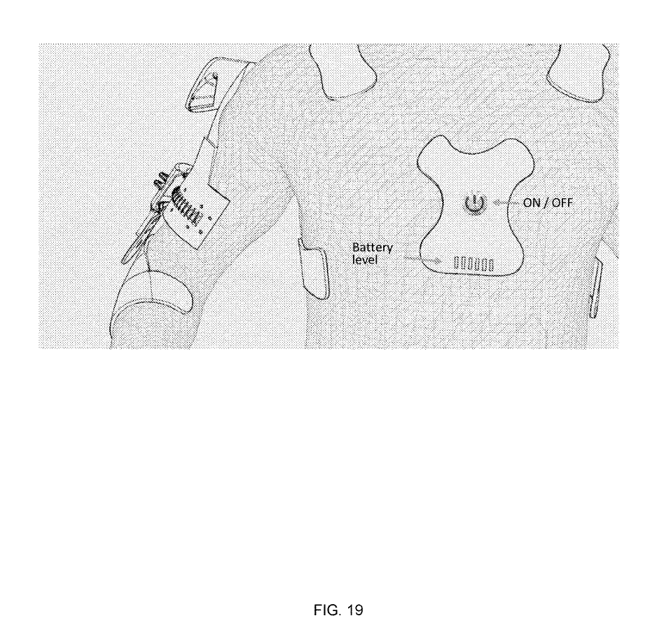

As a preliminary operation, a user may charge the power supply (e.g., battery) of the exoskeleton. For example, as shown in FIG. 19, the user may engage the ON/OFF button to turn on the exoskeleton device, and may determine whether or not a charge is required based on information provided in a battery level indicator. To perform the charging, the user may perform the following operations:

1. Turn the device off, and connect the charger to recharge the power supply.

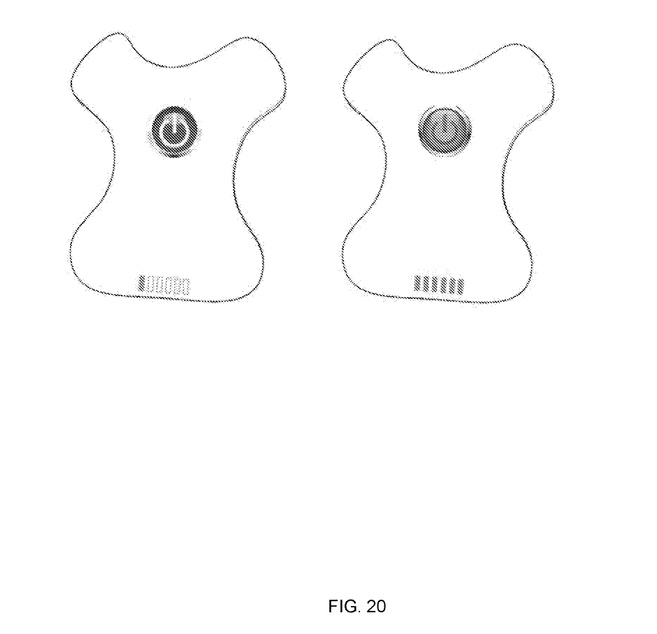

2. Allow the exoskeleton to charge for a prescribed period (e.g., 2-3 hours), or until the power button displays a green light. The power button light may show red during the charge period and green once the process is complete, as shown below in FIG. 20. During the charging process, the battery level indicator light will increase.

3. After the power button light turns green, disconnect the charger. The exoskeleton is ready for use.

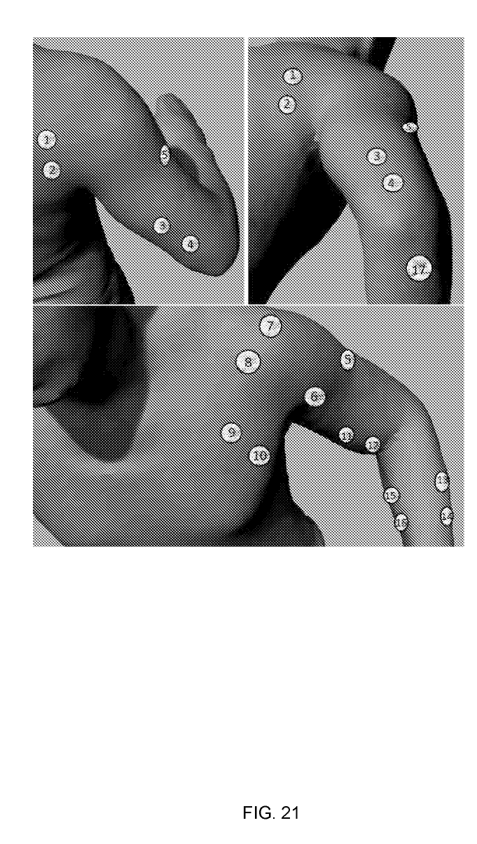

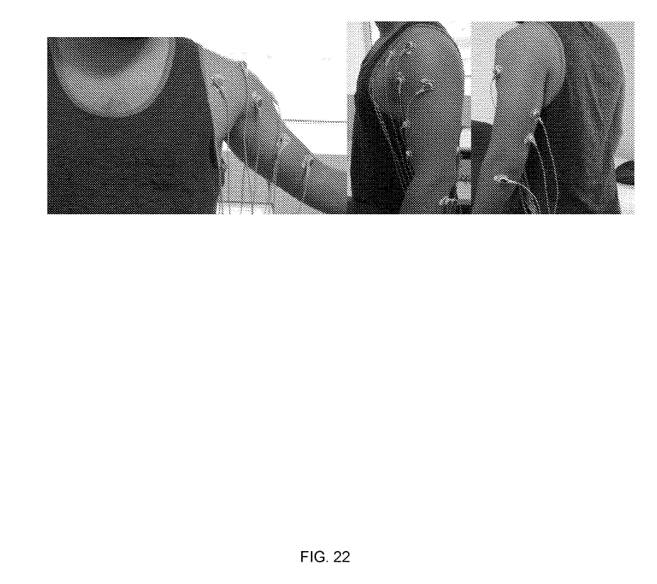

Additionally, a process for a user to wear the exoskeleton for use is provided as follows. In the case of the user that uses disposable electrodes for EMG sensing as explained above must position the electrodes on his or her body, matching a location of a pre-located electrode cable that serves as a location guide. Example positions of the disposable electrodes are illustrated in FIGS. 21 and 22.

In the case of the user that uses the wearable suit having the conductive fabric as explained above, the user simply wears the suit, with the correct location of the EMG sensing areas.

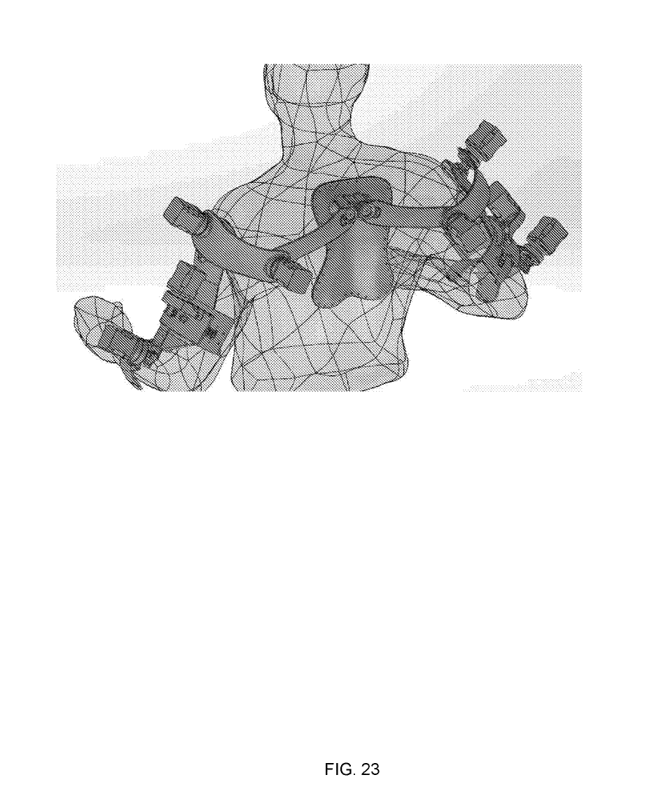

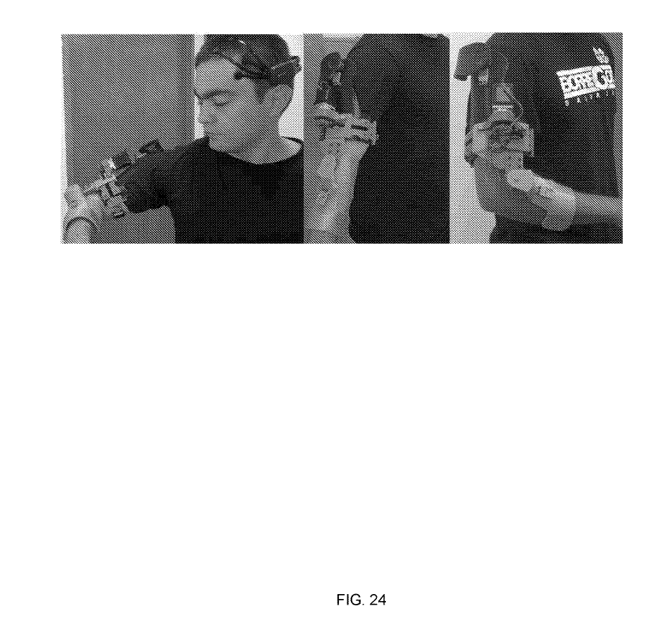

Once the EMG sensor or wearable suit has been employed by the user, the exoskeleton device is worn. The exoskeleton is placed on the user as shown in FIGS. 23 and 24. As explained above, adjustable straps may be provided to fasten the exoskeleton to the body.

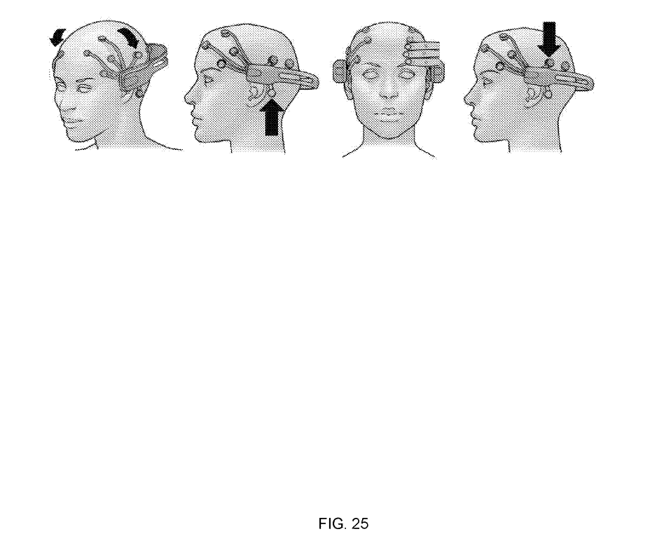

Further, the EEG sensor must be attached to the user. As explained above, a wearable headset may be used as an EEG sensor, which is used in a well-known manner (e.g., hydrate, assemble, pair, and place), as shown in FIG. 25.

As also explained above, an augmented reality device may be employed for the rehabilitation mode of the example implementation. The augmented reality device may be attached as follows (in this example a tablet is used; however, the tablet may be substituted with other similar devices such as a computer, mobile phone, or other similar device as would be understood by those skilled in the art):

1. Connect the augmented reality glasses to the tablet interface.

2. Turn on the glasses.

3. Carefully, place the glasses on user's head, over the EEG headset as explained above. Make sure that the position of the EEG sensor is not modified.

4. Employ the augmented reality interface to perform calibration and select a rehabilitation routine.

The exeskeleton device may be powered on by pressing the button at the front. The light will turn green, then the exoskeleton is ready to be used as follows:

1. Turn on the tablet user interface.

2. Hold for a prescribed time (e.g., 60 seconds) until the screen indicates that the exoskeleton was successfully recognized. The screen may indicate recognizing of each module at a time and legends may be enlightened, such as main controller, EEG, EMG and augmented reality glasses. An end button may appear when all the modules are recognized.

3. Once every module is recognized, the home screen may show two options: “calibration” and “operation mode”. Select calibration.

4. The interface guide the user to calibrate each module.

5. Finally, once the modules are calibrated, the user returns to a home interface and click on operation mode to select between rehabilitation and movement assistant modes.

For the rehabilitation mode, the user may determine whether the tablet or the augmented reality glasses are used as a user interface. In both cases the user will receive step by step instructions regarding the rehabilitation routines. According to an example implementation, a medical doctor or physical therapist of the user may determine the routines from a catalog and adjust parameters including but not limited to velocity, repetition series, days per week, and others. Then, the user may select each prescribed routine.

For the movement assistant mode there is no user interface (e.g., tablet or glasses) as in the rehabilitation mode, due to his purpose of the usage being based on support for daily activities of the user.

When a user selects this operation mode at the tablet home screen, another screen appears to prompt the user to select the type of activities he or she will be doing; based on this information, the engines may be reprogrammed, to ensure that the device will work properly. Then the user may select between activities such as loading heavy objects, home tasks (e.g., cleaning or cooking), or operate a device requiring more precise movement.

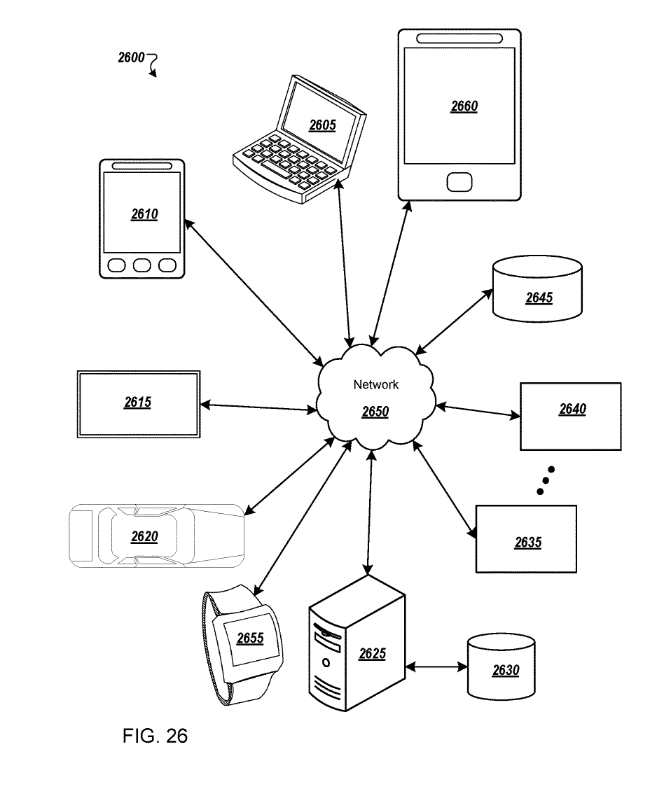

FIG. 26 shows an example environment 2600 suitable for some example implementations. Environment 2600 includes devices 2605-2645, and each is communicatively connected to at least one other device via, for example, network 2660 (e.g., by wired and/or wireless connections). Some devices may be communicatively connected to one or more storage devices 2630 and 2645.

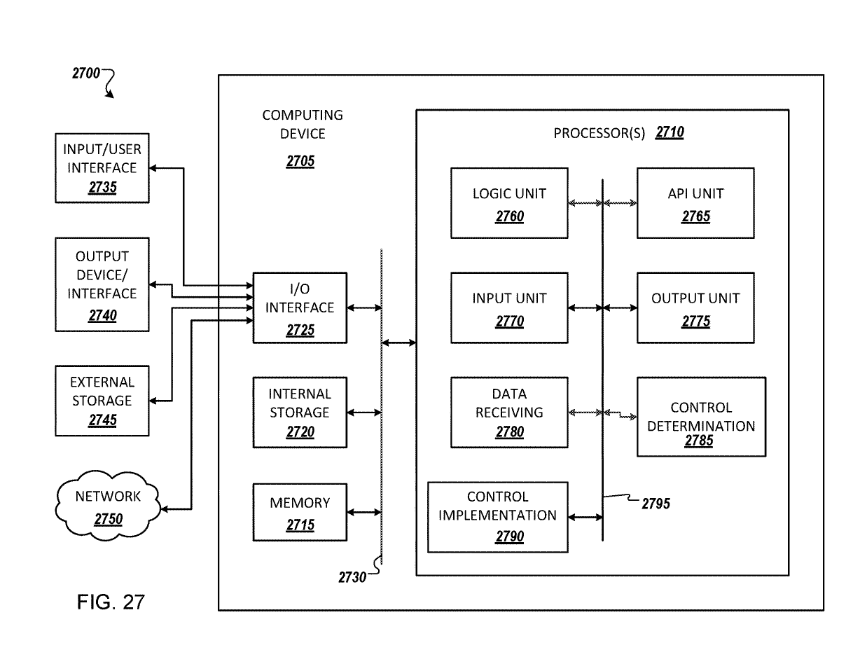

An example of one or more devices 2605-2645 may be computing device 2705 described below in FIG. 27. Devices 2605-2645 may include, but are not limited to, a computer 2605 (e.g., a laptop computing device), a mobile device 2610 (e.g., smartphone or tablet), a television 2615, a device associated with a vehicle 2620, a server computer 2625, computing devices 2635-2640, storage devices 2630 and 2645. Computing devices 2660 illustrate an implementation as a tablet device.

Further computing device 2655 also includes wearable computing devices (e.g. a smartwatch, smart ring, smart bracelet, etc.). In particular, the use of wearable computing devices 2655 may provide additional functionality over tablets, phones, and other computing devices by making the example implementation more compact, lightweight and easy to use for the patient and not interfering with regular activities. The wearable computing device 2655 may also include the above-described exeskeleton device and related peripherals. For example, the wearable computing device 2655 may be considered the controller of the exeskeleton device.

FIG. 27 shows an example computing environment 2700 with an example computing device 2705 suitable for use in some example implementations. A computing device 2705 in computing environment 2700 can include one or more processing units, cores, or processors 2710, memory 2715 (e.g., RAM, ROM, and/or the like), internal storage 2720 (e.g., magnetic, optical, solid state storage, and/or organic), and/or I/O interface 2725, any of which can be coupled on a communication mechanism or bus 2730 for communicating information or embedded in the computing device 2705.

Computing device 2705 can be communicatively coupled to input/user interface 2735 and output device/interface 2740. Either one or both of input/user interface 2735 and output device/interface 2740 can be a wired or wireless interface and can be detachable. Input/user interface 2735 may include any device, component, sensor, or interface, physical or virtual, which can be used to provide input (e.g., voice, buttons, touch-screen interface, keyboard, a pointing/cursor control, microphone, camera, braille, motion sensor, optical reader, and/or the like). Output device/interface 2740 may include a display, television, monitor, printer, speaker, braille, or the like. In some example implementations, input/user interface 2735 and output device/interface 2740 can be embedded with or physically coupled to the computing device 2705. In other example implementations, other computing devices may function as or provide the functions of input/user interface 2735 and output device/interface 2740 for a computing device 2705.

Examples of computing device 2705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 2705 can be communicatively coupled (e.g., via I/O interface 2725) to external storage 2745 and network 2750 for communicating with any number of networked components, devices, and systems, including one or more computing devices of the same or different configuration. I/O interface 2725 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 2700. The Network 2750 may also be used to communicate with an example implementation of a medical device as described herein (e.g. medical device 100 and/or medical device 300). The Network 2750 can be any network or combination of networks.

Computing device 2705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 2705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processors 2710 can execute under any operating system (OS) (not shown), in a native or virtual environment. One or more applications can be deployed that include logic unit 2760, application programming interface (API) unit 2765, input unit 2770, output unit 2775, data receiving unit 2780, control determination unit 2785, control implementation unit 2790, and inter-unit communication mechanism 2795 for the different units to communicate with each other, with the OS, and with other applications (not shown). For example, data receiving unit 2780, control determination unit 2785, control implementation unit 2790 may implement one or more of the processes disclosed herein. The described units and elements can be varied in design, function, configuration, or implementation and are not limited to the descriptions provided.

In some example implementations, when information or an execution instruction is received by API unit 2765, it may be communicated to one or more other units (e.g., logic unit 2760, input unit 2770, output unit 2775, data receiving unit 2780, control determination unit 2785, and control implementation unit 2790). As explained below, data receiving unit 2780 may be implemented to receive information from the patient, such as mode preference, health parameters (measured and/or input), user preferences, or other associated information; the control determination unit 2785 may determine a course of action for the exoskeleton device to take, depending on the received input information; and the control implementation unit 2790 may provide instructions for implementation of the course of action to the exeskeleton device and the associated peripheral devices.

In some instances, logic unit 2760 may be configured to control the information flow among the units and direct the services provided by API unit 2765, input unit 2770, output unit 2775, data receiving unit 2780, control determination unit 2785, and control implementation unit 2790 in some example implementations described above. For example, the flow of one or more processes or implementations may be controlled by logic unit 2760 alone or in conjunction with API unit 2765.

The computing device 2705 may receive the transmitted data indicative of the mode, parameters, patient health condition, health care provider instruction, or other relevant information. The computing device 2705 may receive the transmitted data via wired or wireless connection. For example, the transmitted data may be received via Bluetooth, Wi-Fi, cellular, radio or any other wireless communication technology or via serial connection, parallel port connection, USB connection, Ethernet connection, or any other wired connection.

The computing device 2705 may also provide the user with options to share one or more of the received data and control determination with third parties. For example, the computing device 2705 may allow the user to share the input with third parties via email, SMS message, website posting, social media posting or any other mechanism that may be apparent to a person of ordinary skill in the art. Further, the computing device 2705 may also allow the user to share the input data by uploading to an electronic medical record database or other database of medical information accessible by the user's medical caregivers.

In some implementations, the received data may also be stored locally on the computing device 2705. In some implementations, the computing device may be configured to automatically delete one or more of the received data after the expiration of a certain amount of time. In some example implementations, the computing device may also be configured to encrypt the stored received data. Further, in some implementations, the computing device 2705 may be configured to delete all received data stored locally by a simple user operation.

The foregoing detailed description has set forth various example implementations of the devices and/or processes via the use of block diagrams, schematics, and examples. Insofar as such block diagrams, schematics, and examples contain one or more functions and/or operations, each function and/or operation within such block diagrams, flowcharts, or examples can be implemented, individually and/or collectively, by a wide range of hardware, software, firmware, or virtually any combination thereof.

In one example implementation, the present subject matter may be implemented via Application Specific Integrated Circuits (ASICs). However, the example implementations disclosed herein, in whole or in part, can be equivalently implemented in standard integrated circuits, as one or more programs executed by one or more processors, as one or more programs executed by one or more controllers (e.g., microcontrollers), as firmware, or as virtually any combination thereof.

Additionally, it is noted that the foregoing example implementations have been shown for various joints. However, each part is independently operational, and can be attached with the other parts to form a full-body exoskeleton, or only a part thereof can be used (e.g., knee, shoulder, single full arm, leg, etc.). Thus, the parts are detachably attachable in segments, as would be known by those skilled in the art. For example, but not by way of limitation, the example implementation may include up to 15 joint-level exoskeletons, such as neck, back, left and right shoulder, left and right arm, left and right wrist, hip, left and right leg, left and right calf, and left and right ankle. Each of these exoskeletons may be controlled at the system level by the above-described controller, so as to perform in a coordinated manner. Alternatively, one or more of the exoskeletons may be used individual or in some manner of subcombination, such a subset of the joints of a body are covered by the exoskeleton, as opposed to the entire body.

The foregoing example implementations disclose the use of EMG and EEG signals. However, according to an example implementation in which rehabilitation routines are run, EMG and EEG signals may be excluded therefrom.

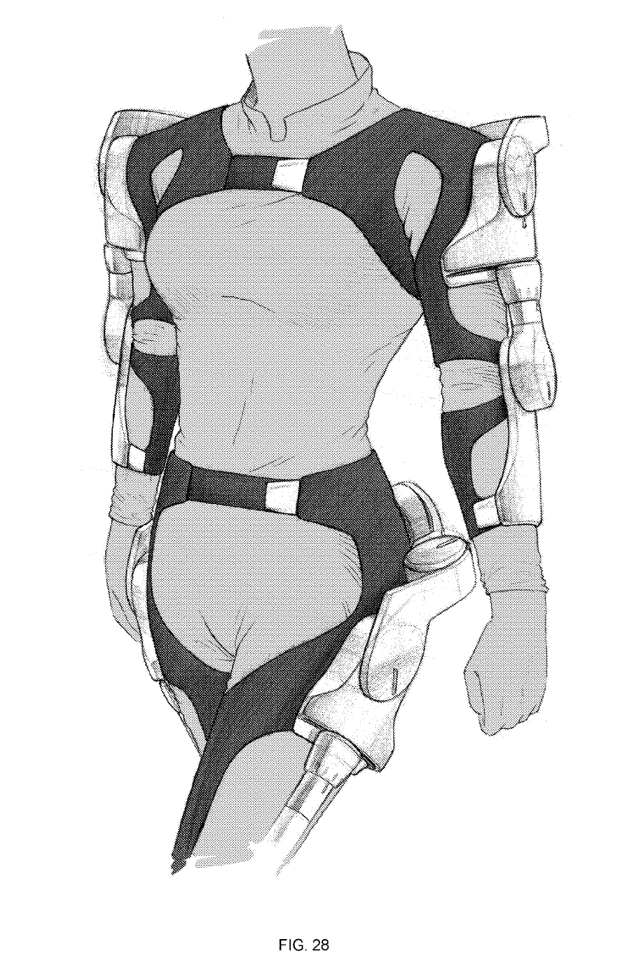

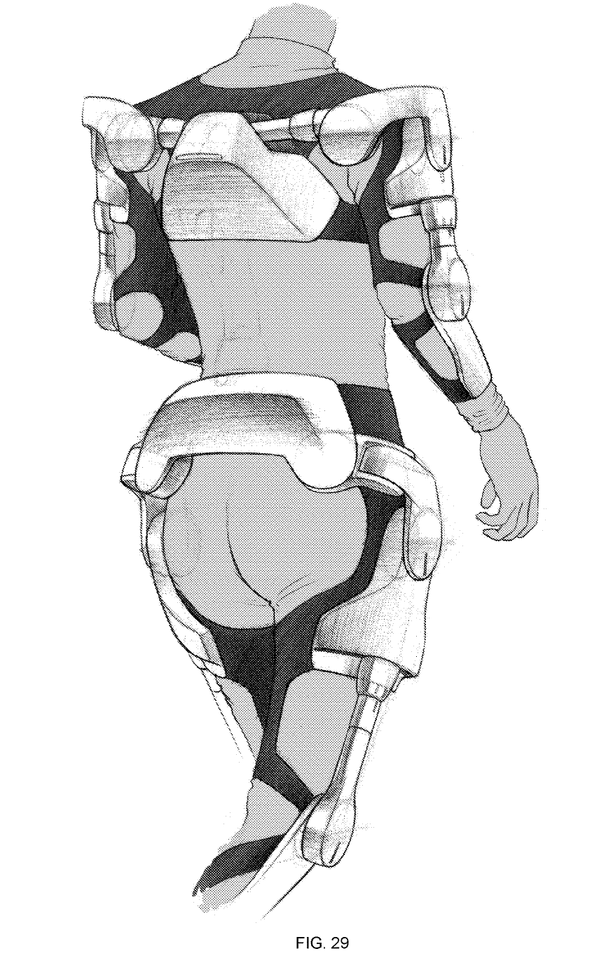

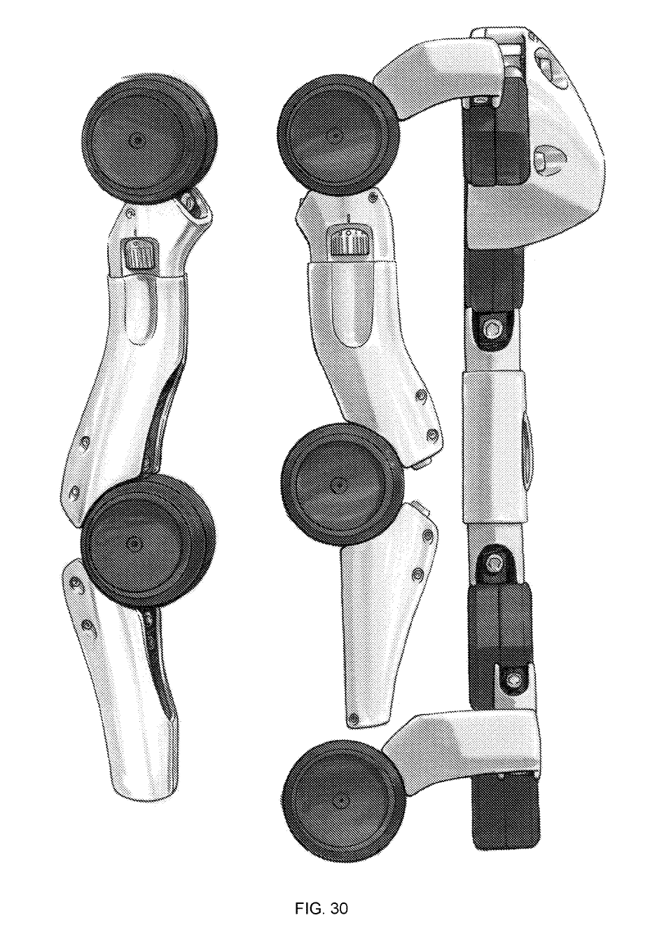

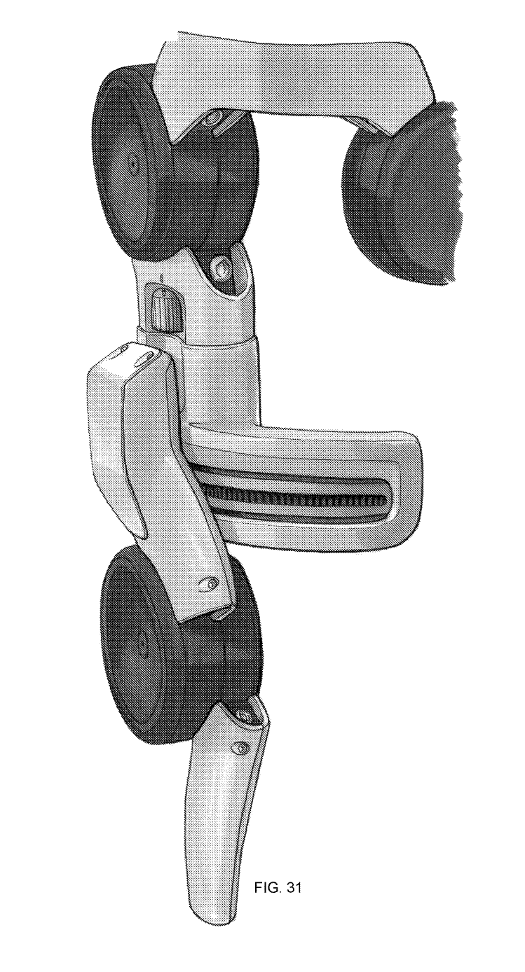

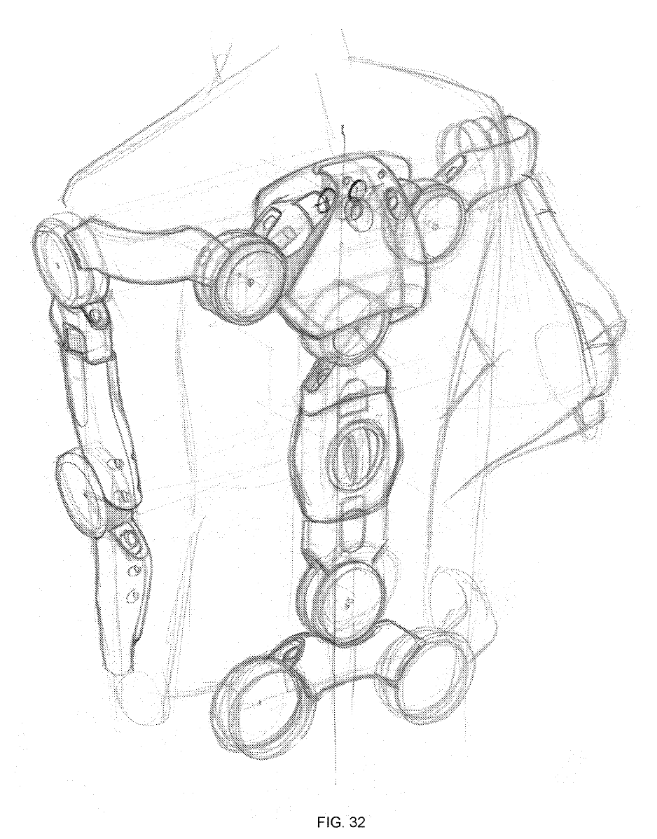

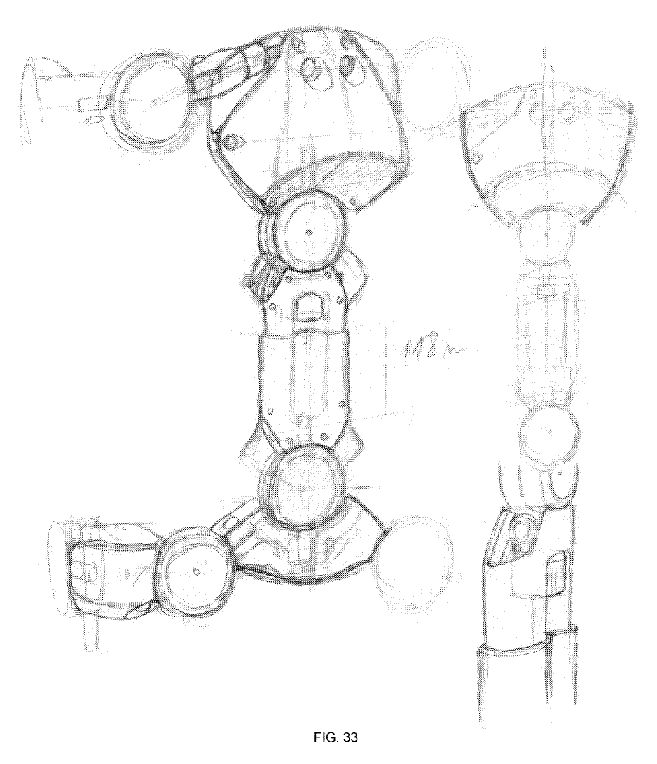

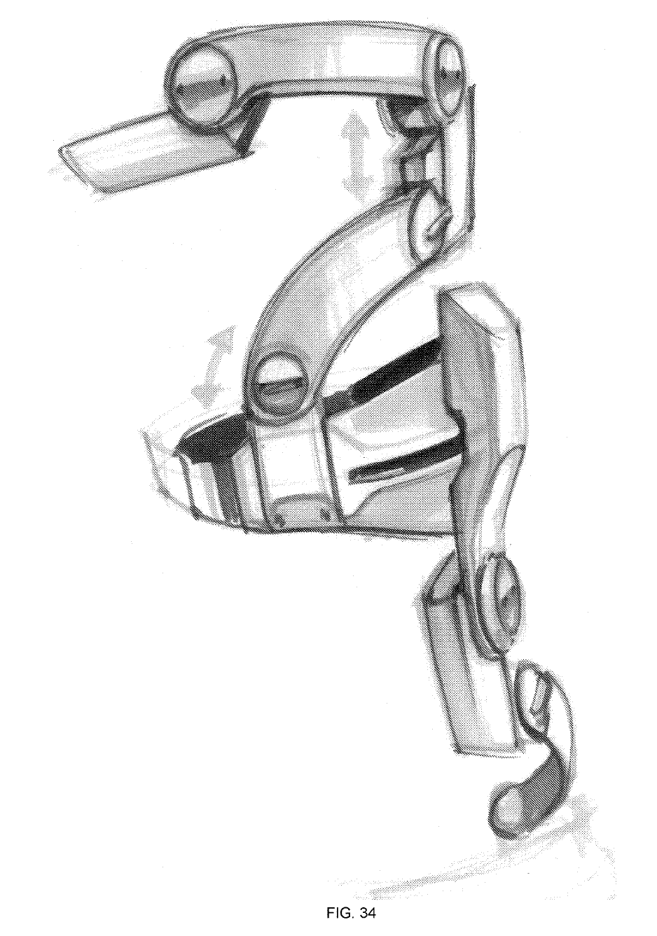

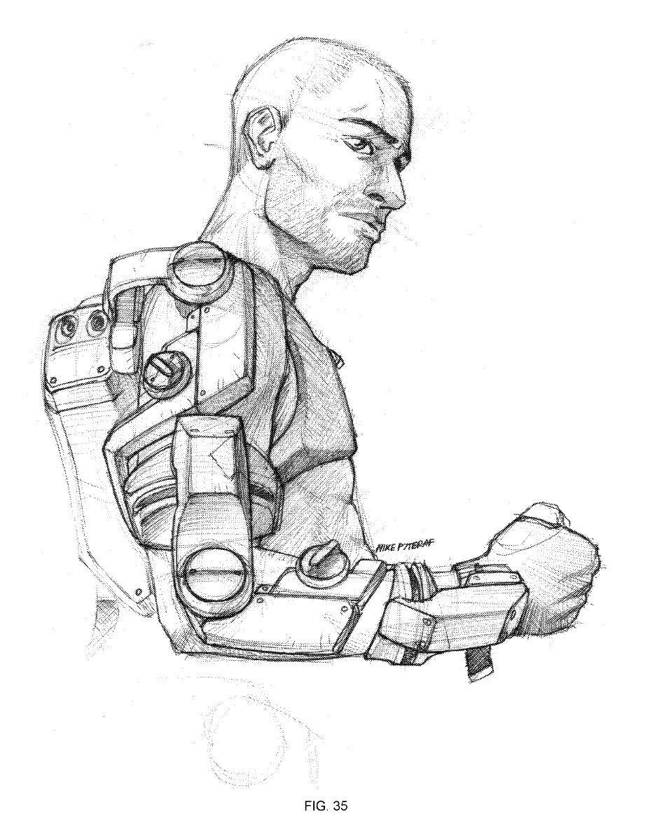

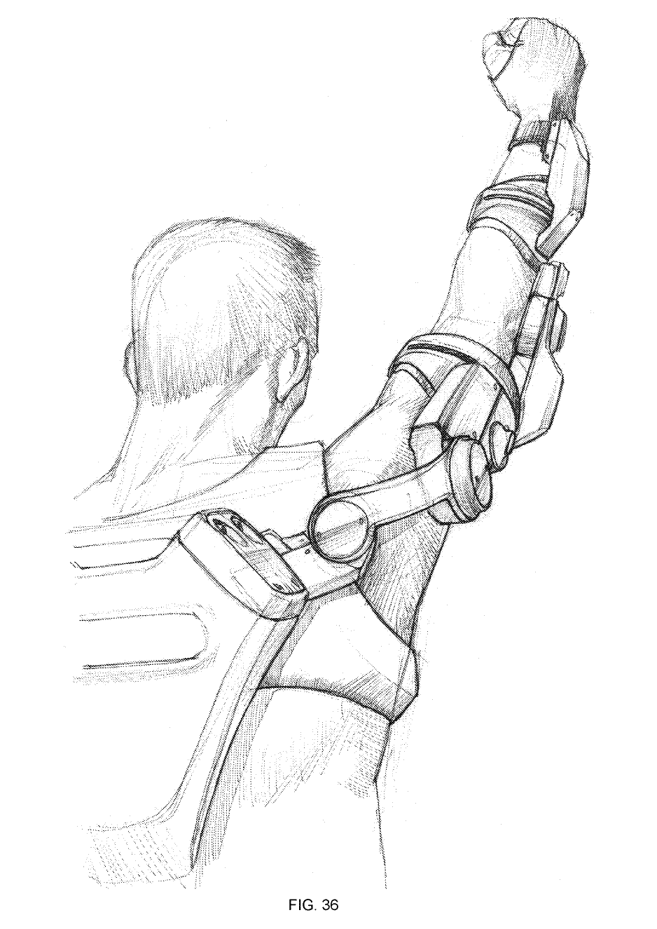

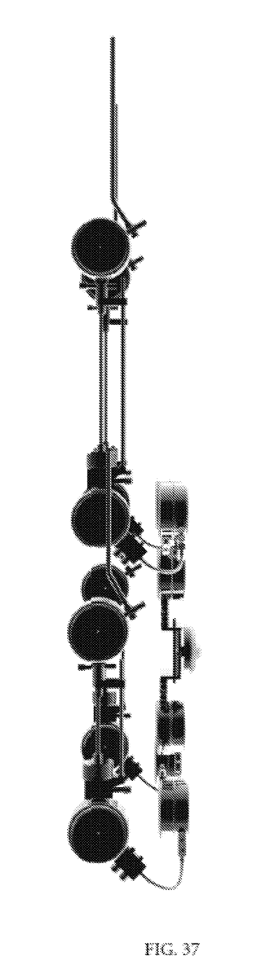

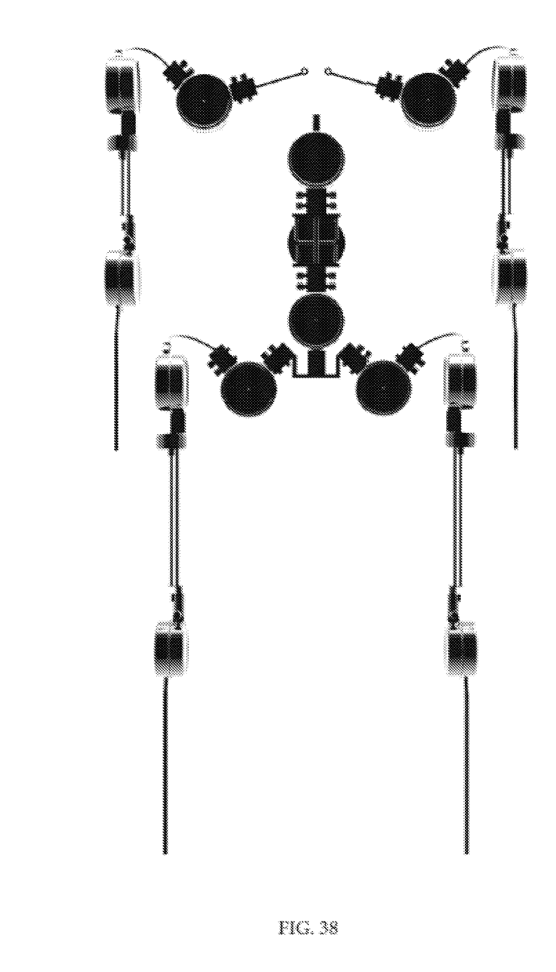

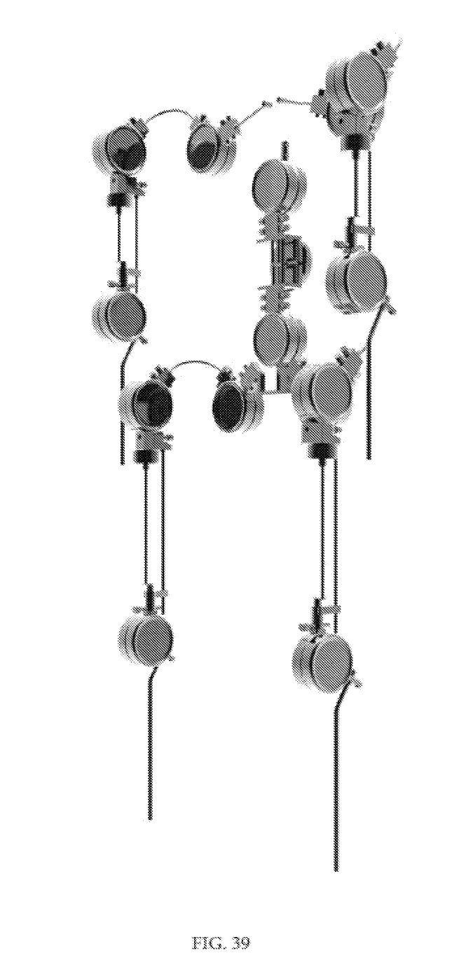

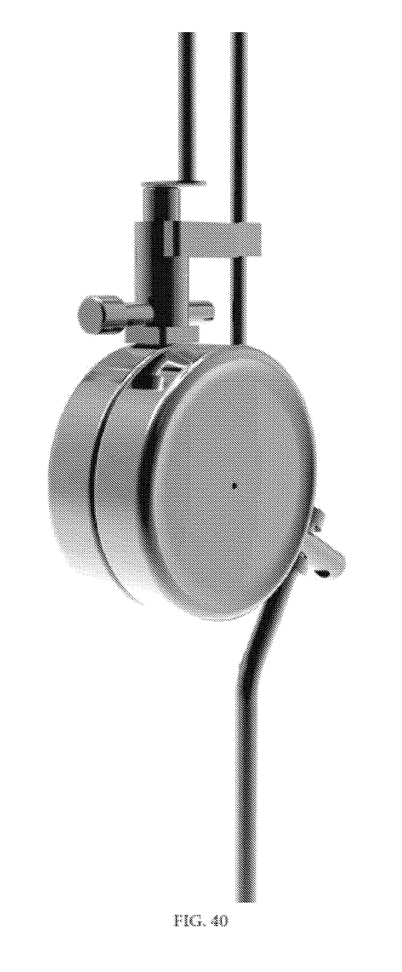

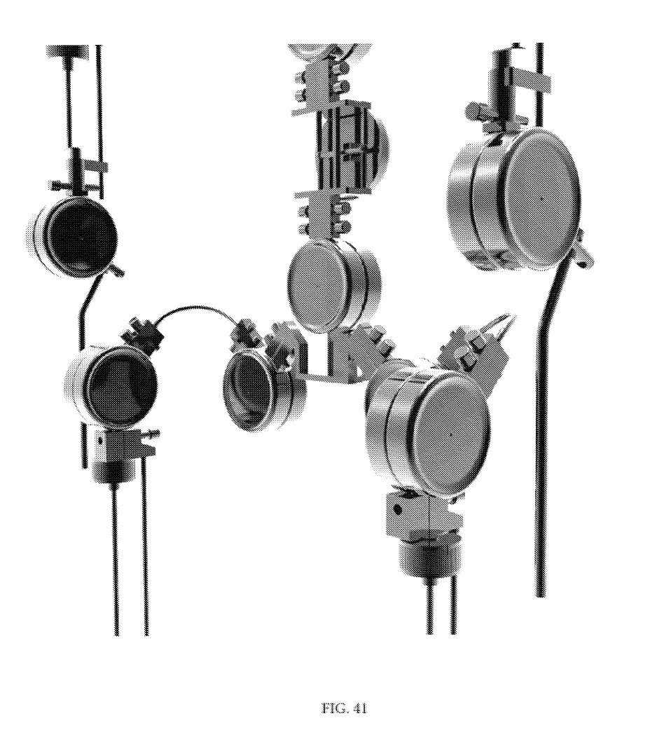

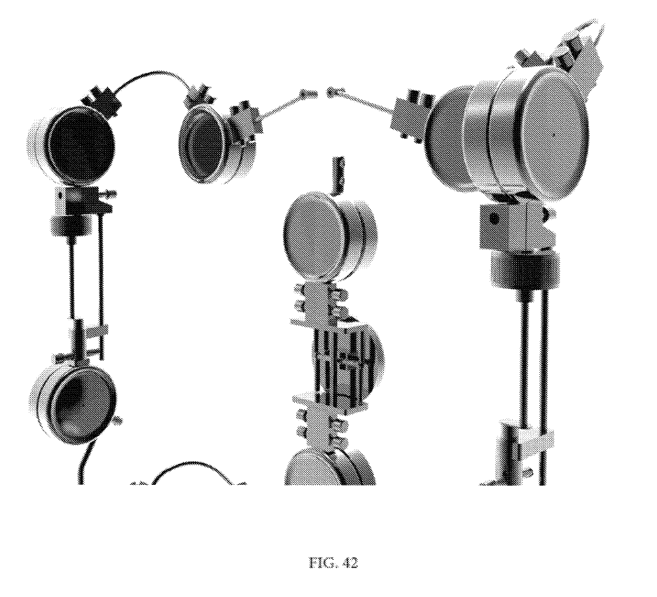

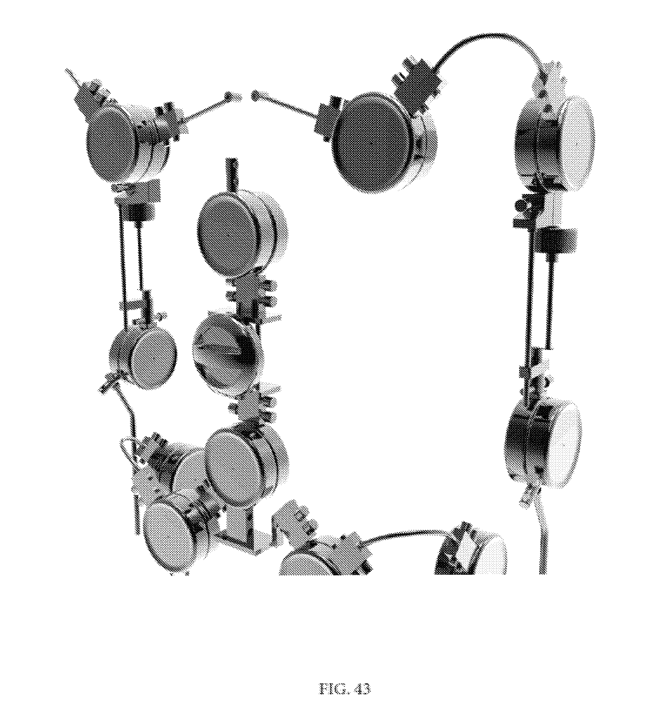

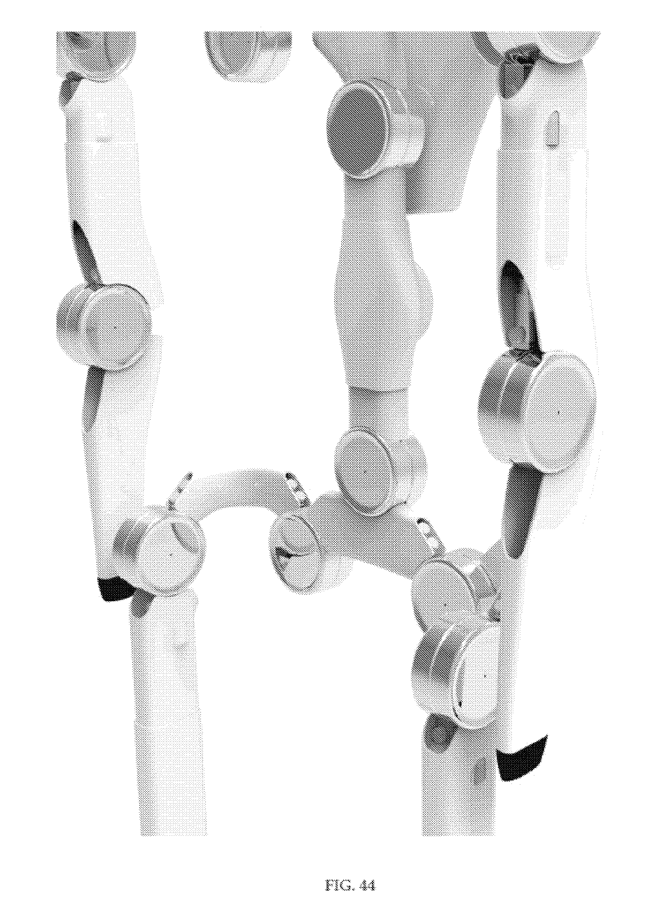

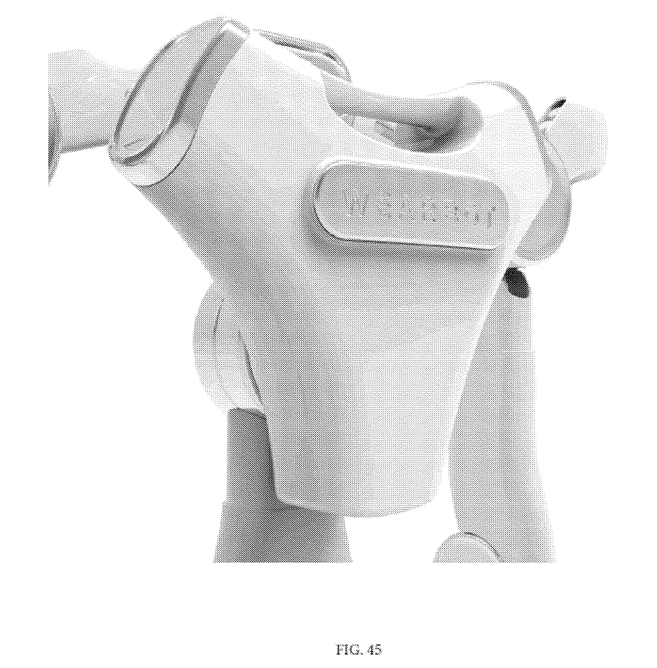

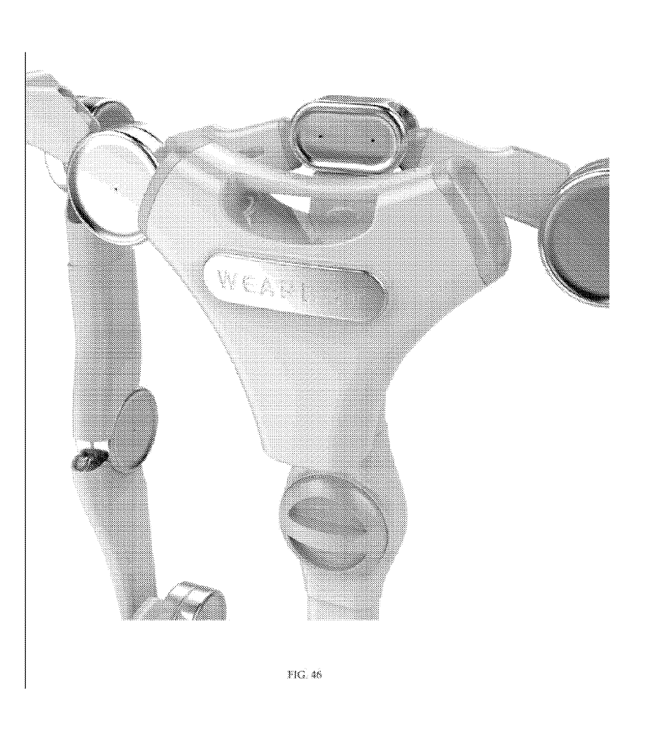

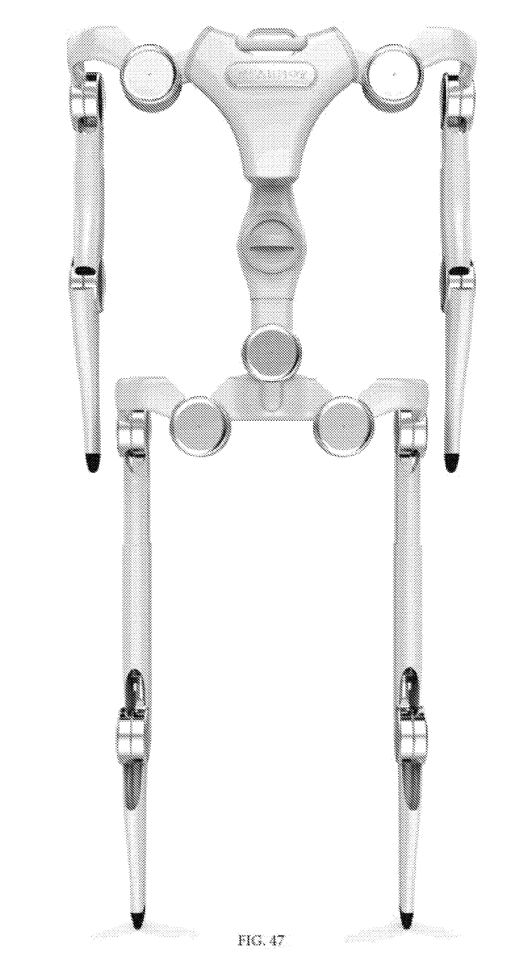

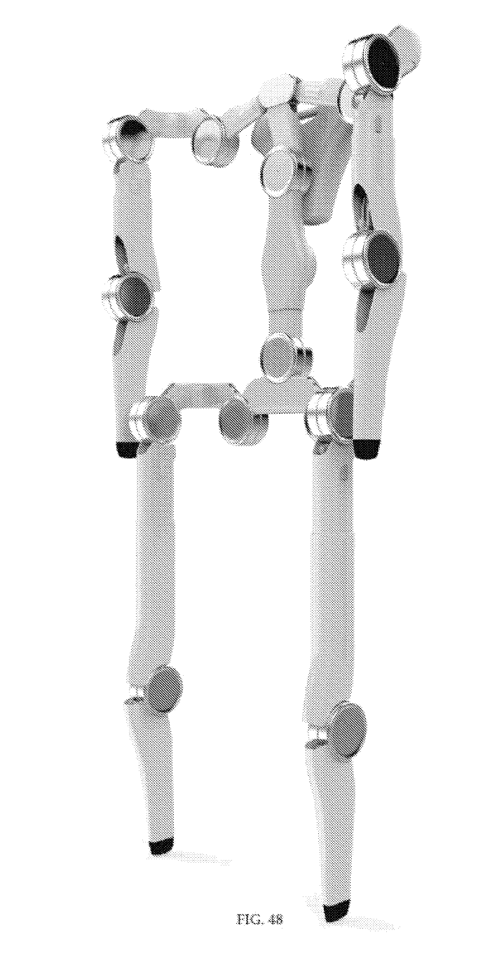

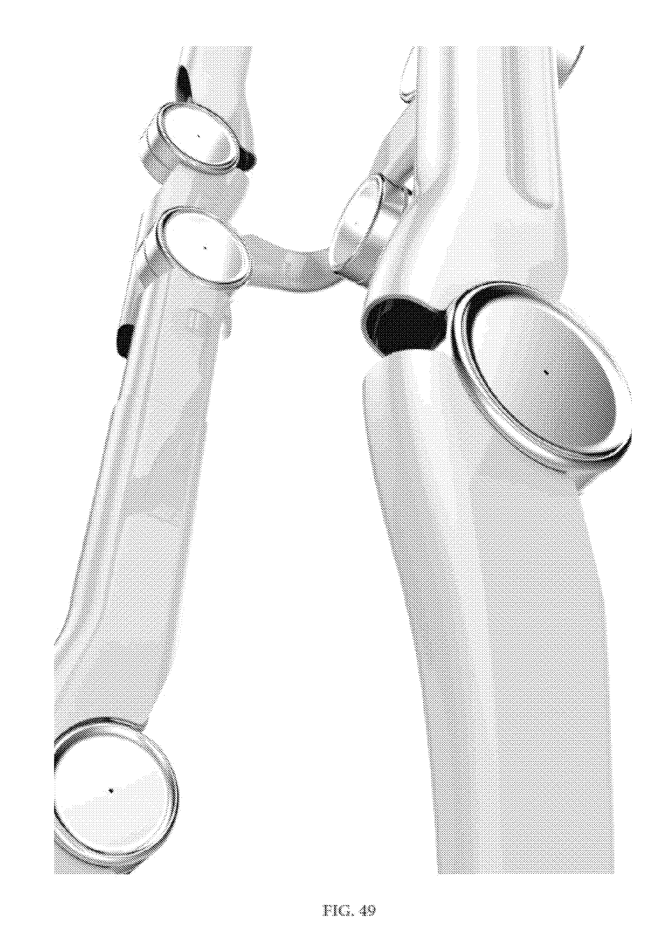

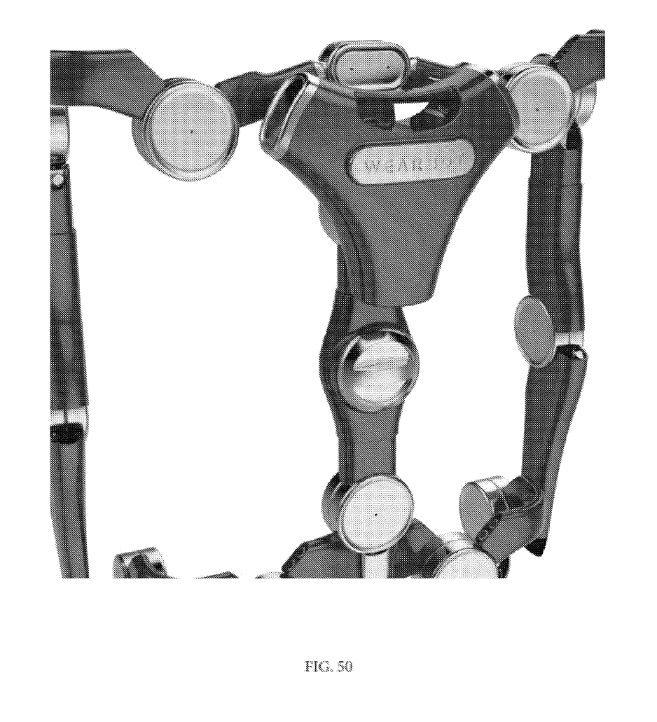

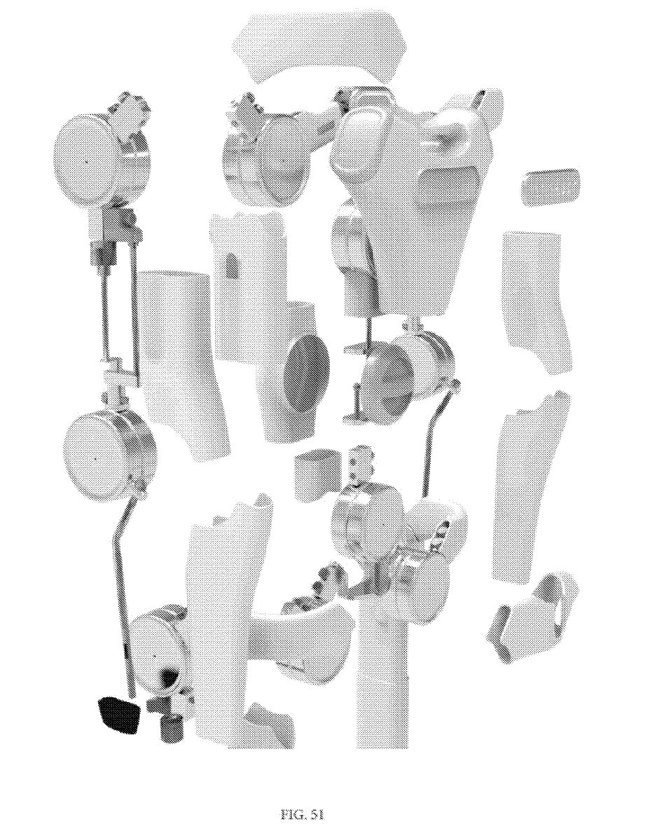

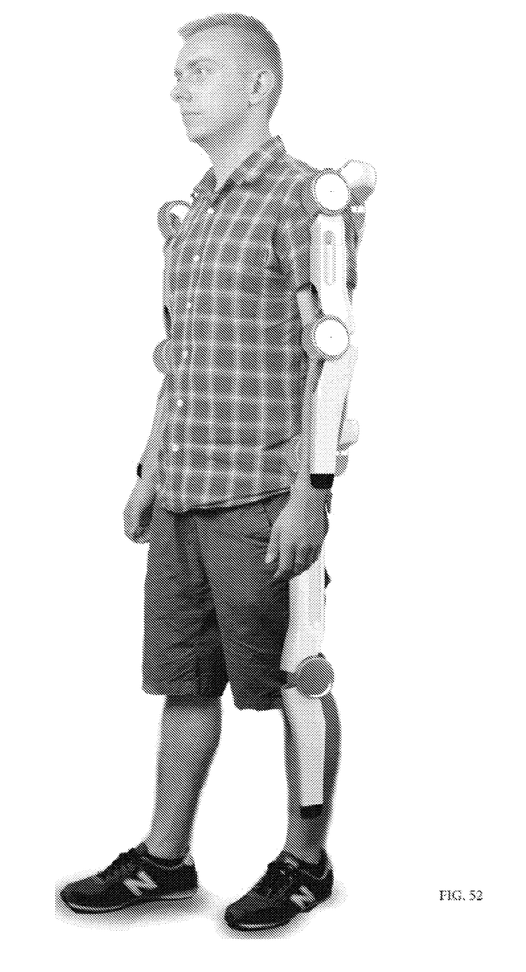

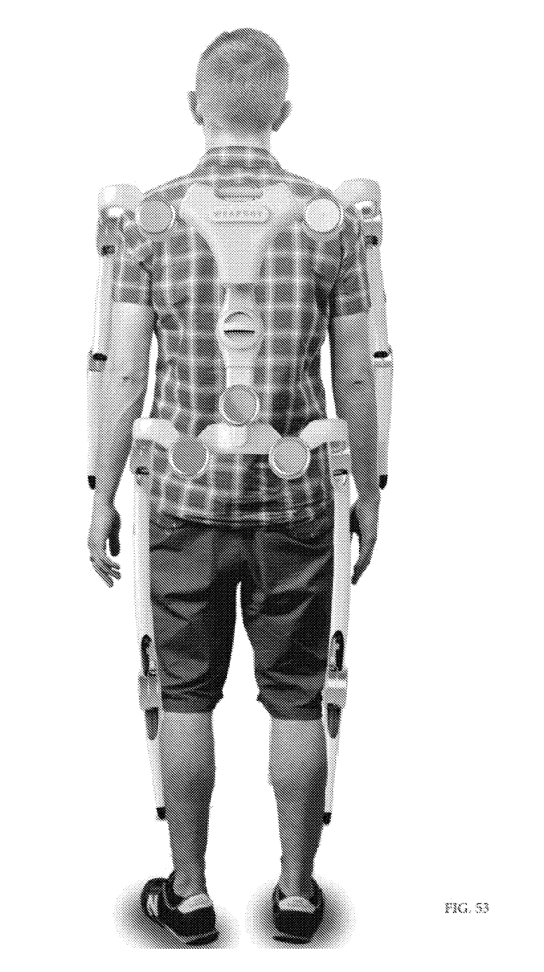

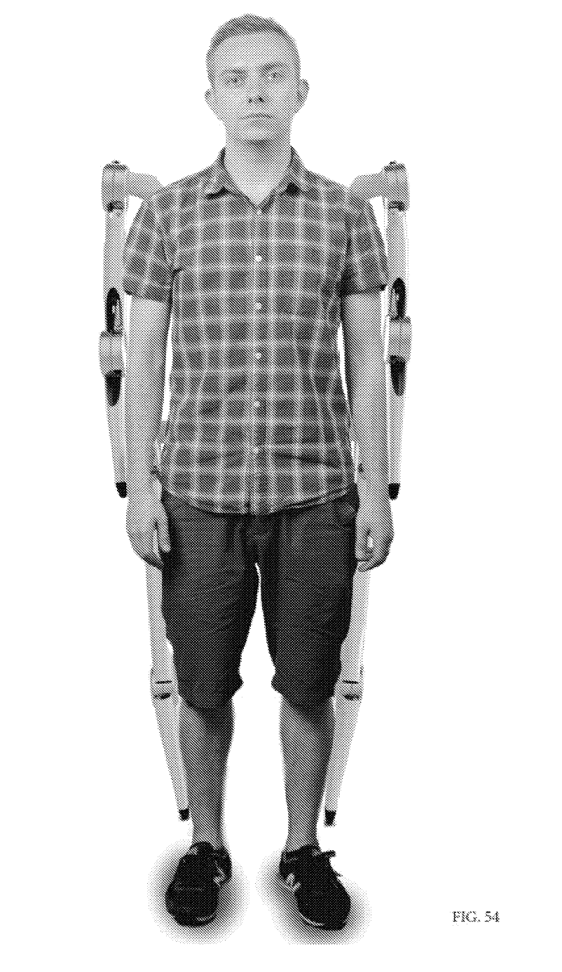

FIGS. 28-54 provide additional use examples of the example implementations. For example, FIGS. 28-29 illustrate a front and back sketch of a user having the cover layer that includes that EMG areas, and exoskeletons for arms, shoulders, hips, legs, and back. FIGS. 30-36 illustrate various exoskeletons in individual and combined use. FIGS. 37-43 illustrate the exoskeleton in various combinations according to another example implementation. FIGS. 44-50 illustrate the exoskeleton in various combinations according to another example implementation, and FIG. 51 illustrates a disassembled view of the example implementation. For example, FIGS. 52-54 illustrate a front and back sketch of a user having exoskeletons for upper and lower arms, shoulders, hips, upper and lower legs, and back.

While certain example implementations have been described, these example implementations have been presented by way of example only, and are not intended to limit the scope of the protection. Indeed, the novel methods and apparatuses described herein may be embodied in a variety of other forms. Furthermore, various omissions, substitutions, and changes in the form of the methods and systems described herein may be made without departing from the spirit of the protection. The accompanying claims and their equivalents are intended to cover such forms or modifications as would fall within the scope and spirit of the protection.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

1. A medical device for non-invasively assisting movement of a first part of a body, the medical device comprising:
a stationary piece configured to be attached to a second part of the body;
a movable piece configured to be attached to the first part of the body;
an actuator that connects the stationary piece to the movable piece and is configured to move the movable piece relative to the stationary piece; and
a controller that receives an input signal and generates a control signal to control a movement of the actuator, based on the received input signal.

2. The medical device of claim 1, further comprising a body cover that covers the body, and is interspersed between the body and the medical device.

3. The medical device of claim 2, further comprising an electromyography-sensitive region on the body cover that senses electrical potential generated by a muscle in the first part of the body, and provides the input signal to the controller.

4. The medical device of claim 1, further comprising an electromyography sensor remotely positioned from the medical device on the first part of the body, wherein the electromyography sensor senses electrical potential generated by a muscle in the first part of the body, and provides the electrical potential as the input signal to the controller.

5. The medical device of claim 1, further comprising an electroencephalograph (EEG) sensor remotely positioned on a third part of the body, wherein the EEG sensor senses neural information of the body, and provides the neural information as the input signal to the controller.

6. The medical device of claim 1, wherein the input signal comprises an instruction generated by at least one of a health care service provider and a user associated with the body.

7. The medical device of claim 1, wherein the input signal comprises an instruction to operate in a first mode associated with supplementing a strength, torque or force of the first part of the body to assist with motor tasks for the body, or a second mode associated with a rehabilitation of the first part.

8. The medical device of claim 7, wherein for the input signal comprising the instruction to operate in the second mode, the medical device further comprises an augmented reality user interface that provides a user with a routine to support the rehabilitation of the first part of the body.

9. The medical device of claim 1, wherein the first part of the body is a joint, and the actual is a rotary actuator associated with assisting in movement of the joint.

10. The medical device of claim 2, wherein the medical device comprises a non-invasive mechatronic device providing joint mobility using EEG and EMG signals that is carried by a person and includes a control system connected wirelessly to a set of EEG sensors, in the form of a headband or cap, in constant communication while the non-invasive mechatronic device is on, and by a wired connection to at least one exoskeleton that may be coupled to one or more other exoskeletons, each surrounding a joint to assist in its motion or rehabilitation, wherein the non-invasive mechatronic device is calibrated by connection to an electronic device, and is embedded in a garment that is worn on the user's body and comprises:
a. a processor that is operationally connected to:
b. an on/off switch to turn the device on or off, the device being connected to,
c. a USB port enabling communication with the electronic device for calibration of the mechatronic device,
d. a memory port for storing information relating to the rehabilitation routines or motion assistant,
e. at least one wireless connection module for wireless communication with the set of EEG sensors, with an electronic device such as a computer, cell phone or tablet;
f. a routine selector enabling the information related to the rehabilitation routine or motion assistant selected to be downloaded and implemented, which sends information to,
g. a screen for displaying data relating to calibration and the routines to be performed,
h. a power source for energizing the mechatronic device, which is connected to:
i. a power interface that powers at least one exoskeleton comprising said actuator per degree of freedom of the joint, where the actuator is connected to (a) a static link made of a rigid material surrounding the proximal muscle of the joint that is attached using at least one adjustable band, (b) a movable link made of rigid material that surrounds the distal muscle of the joint that is attached using at least one adjustable band, and (c) a set of non-invasive EMG sensors per degree of freedom of the joint to sense the level of muscular effort and/or the pain threshold of the user's muscle.

11. The medical device as claimed in claim 10, wherein the routine selector enables the operating mode of the device to be selected from the following: calibration, rehabilitation or motion assistant.

12. The medical device as claimed in claim 10, wherein in the routine selector, calibration mode can be cognitive or electromyographic, selecting the option on the screen.

13. The medical device as claimed in claim 10, wherein it controls at least one exoskeleton that can be coupled to one or more other exoskeletons.

14. The medical device as claimed in claim 10, wherein there a set of EMG sensors are provided to detect myoelectric activity in each joint.

15. The medical device as claimed in claim 10, wherein at least one exoskeleton assists movement in a given joint for up to three degrees of freedom.

16. The medical device as claimed in claim 15, wherein when the at least one exoskeleton is controlling three degrees of freedom, it comprises (a) three actuators, one per degree of freedom in the joint and (b) three sets of EMG sensors.

17. The medical device as claimed in claim 10, wherein the at least one exoskeleton is made of rigid material to withstand deformations, and that is waterproof, lightweight, corrosion resistant, and resistant to impacts and stress to prevent fracturing under normal operating loads and is made of at least one of (a) thermoplastics such as acrylonitrile butadiene styrene (ABS), (b) metals such as aluminum, (c) alloys such as steel, or (d) composite materials such as carbon-fiber reinforced polymers.

18. The medical device as claimed in claim 1, wherein the actuator is one of the following: electric motor, pneumatic motor or hydraulic motor, or a combination of the abovementioned;

19. The medical device as claimed in claim 18, wherein the actuator is used for assisting the movement of a given joint.

20. The medical device as claimed in claim 18, wherein the actuator is used to assist rehabilitation of a given joint.

21. The medical device of claim 1, wherein the controller comprises a non-transitory computer-readable medium configured to provide instructions for a medical device for non-invasively assisting movement of a first part of a body, the medical device including a stationary piece configured to be attached to a second part of the body, a movable piece configured to be attached to the first part of the body, and an actuator that connects the stationary piece to the movable piece and is configured to move the movable piece relative to the stationary piece, the instructions, comprising:
receiving an input from an external source, wherein the input comprises at least one of a received body parameter associated with muscle activity or neural activity, and an input generated by a user or a health care service provider;
processing the input to determine whether a mode of the medical device is in a motor task assistance mode or a rehabilitation support mode, and to determine the level of assistance based on at least one of the muscle activity and the neural activity;
generating a control signal that determines the movement of the actuator, based on the determined level of assistance and the determined mode of the medical device; and
transmitting the control signal to the actuator, with an instruction for the actuator to move in a prescribed manner.

22. The medical device of claim 21, wherein the external source comprises an electromyography sensor remotely positioned from the medical device on the first part of the body, wherein the electromyography sensor senses electrical potential generated by a muscle in the first part of the body, and provides the electrical potential as the input signal to the controller.

23. The medical device of claim 21, wherein the external source comprises an electroencephalograph (EEG) sensor remotely positioned on a third part of the body, wherein the EEG sensor senses neural information of the body, and provides the neural information as the input signal to the controller.

24. The medical device of claim 21, wherein the input signal comprises an instruction generated by at least one of a health care service provider and a user associated with the body.

25. The medical device of claim 21, wherein the input signal comprises the mode of the medical device.

26. The medical device of claim 21, wherein for the input signal comprising the instruction to operate in the rehabilitation support mode, an augmented reality user interface provides a user with a routine to support the rehabilitation of the first part of the body.

27. The medical device of claim 21, wherein the first part of the body is a joint, and the actual is a rotary actuator associated with assisting in movement of the joint.
